(19) United States
(12) Patent Application Publication
(10) Pub. No.: US 2012/0095834 A1
(43) Pub. Date: Apr. 19, 2012

(54) SYSTEMS AND METHODS FOR USING A BEHAVIOR HISTORY OF A USER TO AUGMENT CONTENT OF A WEBPAGE

(76) Inventors: Toby Doig, Herts (GB); Ian Cackett, London (GB)

(21) Appl. No.: 12/905,671

(22) Filed: Oct. 15, 2010

(51) Int. Cl. G06Q 30/00

(52) U.S. Cl. 705/14.53

(57) ABSTRACT

The present disclosure is related to systems and method for selecting keywords to augment on a web page based on a behavior history of a user. The system may include a profiler storing to a user profile identified by a unique identifier interactions of a user with one or more keywords on one or more web pages visited by the user. The interactions may be received from an agent of a client. The one or more keywords augmented with content from the server. The system may include a server receiving from the agent content of a web page being loaded on the client for the user. The server may determine keywords from the content of the web page that match a predetermined set of keywords of one or more campaigns for the web page. The server may identify that one or more of the matching keywords are stored in the user profile and may change, responsive to this identification, a ranking of the matching keywords based on the user profile. The server may transmit to the agent a set of matching keywords and their corresponding campaigns based on the changed ranking.

A portion of the disclosure of this patent document contains material which is subject to copyright protection. The copyright owner has no objection to the facsimile reproduction by anyone of the patent document or the patent disclosure, as it appears in the file or records of the Patent and Trademark Office, but otherwise reserves all copyrights whatsoever.

### FIELD OF INVENTION

This patent application generally relates to systems and methods of augmenting content on a web page. In particular, the present application relates to systems and methods for using behavior history of a user to augment content of a webpage.

### BACKGROUND

An enterprise serving web pages to a user may wish to provide the user with an easier and quicker access to information the user is looking for. The services of the enterprise may aim to increase the user's satisfaction by decreasing the amount of time the user spends finding the relevant information. As the user searches the world wide web for the relevant information, the user may often open many new web pages which do not include the relevant content. Old web pages from which the user began searching are sometimes closed or lost during the search process. The enterprise may wish to provide the user with an option to find the relevant information without having to exit the current web page in order to access a next one, which may or may not include the information the user is looking for.

Hypertext is a computer-based text used in a web page to provide information to a user and organize the web page content into interconnected associations. These associations may enable the user to easily access information the user chooses or clicks. An instance of such an association is called a hyperlink or hypertext link. A hyperlink, when selected, leads the viewer to another web page (or file or resource, collectively called the destination page). In order to access the supplemental information provided through hyperlinks, viewers may be required to leave their current web pages, which may interrupt a viewer's web browsing experience. In addition, hyperlinks are traditionally generated by human editors, a process that can be both tedious and subject to human errors. In some cases, by the time a viewer tries to visit a destination page of a hyperlink, the destination page may cease to exist or have evolved to no longer provide the related information. In other cases, a user may have to search for other destination pages to try to obtain the desired information. This may lead the user to perform multiple searches and visit several pages to find the desired information. These are some aspects in which illustrates that conventional systems are not optimally designed or configured to enhance users' online experience.

### BRIEF SUMMARY OF THE INVENTION

Systems and methods of the present solution provide an individualized approach to delivering targeted content responsive to the behavior of a user. The system creates and maintains a profile for a user which tracks the user's interaction and behavior with a web page. By storing and analyzing the profile, the system is able to provide more relevant content to the user based upon the user's behavior and history. Continuous updates to the user profile permit the system to provide up-to-date and relevant content responsive to the user's evolving or changing behavior.

The behavioral/personalization approach provides systems and methods no present adverts which are more relevant to the user based on things they've looked and interacted with in the past. A unique id is assigned to each user and each time they view a page, an advert or click on something this behavior is recorded against their id. From this a history of each user and next time they view a page the selection of adverts can be influenced (based on what they've seen previously. As a user's behavior changes over time so would the decisions over the advert selection.

In some aspects, the present invention is directed to a method for selecting keywords to augment on a web page based on a behavior history of a user. The method may include storing, by a profiler to a user profile, interactions of a user, received from an agent of a client, with one or more keywords on one or more web pages visited by the user. The one or more keywords may be augmented with content from the server. The method further includes receiving, by the server from the agent of the client, content of a web page being loaded on the client for the user and determining keywords from the content of the web page that match a predetermined set of keywords of one or more campaigns for the web page. The method also includes identifying, by the server, one or more of the matching keywords are stored in the user profile and changing, by the server responsive to the identification, a ranking of the matching keywords based on the user profile. The server may transmit to the agent a set of matching keywords and their corresponding campaigns based on the changed ranking.

In some embodiments, the method includes assigning, by the profiler, a unique identifier to the user. In some embodiments, the method includes transmitting, by the server to the client of the user, a cookie comprising the unique identifier of the user. In some embodiments, the method includes determining, by the server, one or more metrics for the one or more keywords and storing the one or more metrics to the user's profile. In some embodiments, the method includes merging, by the profiler, the one or more metrics with keyword metrics stored in the user profile and storing the merged keyword metrics to the user profile. In some embodiments, the method includes calculating, by the profiler, a weighted average of the one or more keyword metrics and keyword metrics stored in the user profile and storing the weighted average keyword metrics to the user profile.

In some embodiments, the method further includes identifying, by the agent, a mouse over of one or more keywords on each web page the user visits, and transmitting the identified one or more keywords to the profiler to store to the user profile. The method may also include identifying, by the agent, a click of one or more keywords on each web page the user visits, and transmitting the identified one or more keywords to the profiler to store to the user profile. The server may rank the matching keywords. The server may assign a weighted score to each of the one or more matching keywords.

In some embodiments, the method includes upweighting, by the server, a metric for a keyword previously stored in the user profile and received by the server for the web page. In some embodiments, the method includes determining, by the server, one or more keywords to augment on a second web page based on a first set of keyword metrics stored in the user profile and a second set of keyword metrics identified for the currently displayed second web page.

In some aspects, the present invention is related to a system for selecting keywords to augment on a web page based on a behavior history of a user. The system may include a profiler storing to a user profile identified by a unique identifier interactions of a user with one or more keywords on one or more web pages visited by the user. The interactions may be received from an agent of a client. The one or more keywords augmented with content from the server. The system may include a server receiving from the agent content of a web page being loaded on the client for the user. The server may determine keywords from the content of the web page that match a predetermined set of keywords of one or more campaigns for the web page. The server may identify that one or more of the matching keywords are stored in the user profile and may change, responsive to this identification, a ranking of the matching keywords based on the user profile. The server may transmit to the agent a set of matching keywords and their corresponding campaigns based on the changed ranking.

In some embodiments, the profiler assigns a unique identifier to the user. In some embodiments, the server transmits to the client of the user, a cookie comprising the unique identifier of the user. In some embodiments, the server determines one or more metrics for the one or more keywords and stores the one or more metrics to the user profile. In some embodiments, the profiler merges the one or more metrics with keyword metrics stored in the user profile and stores the merged keyword metrics to the user profile. In some embodiments, the profiler calculates a weighted average of the one or more keyword metrics and keyword metrics stored in the user profile and stores the weighted average keyword metrics to the user profile.

In some embodiments, the agent identifies a mouse over of one or more keywords on each web page the user visits, and transmits the identified one or more keywords to the profiler to store to the user profile. In some embodiments, the agent identifies a click of one or more keywords on each web page the user visits, and transmits the identified one or more keywords to the profiler to store to the user profile. In some embodiments, the server ranks the matching keywords. In some embodiments, the server assigns a weighted score to each of the one or more matching keywords. In some embodiments, the server upweights a metric for a keyword previously stored in the user profile and received by the server for the web page. In some embodiments, the server determines one or more keywords to augment on a second web page based on a first set of keyword metrics stored in the user profile and a second set of keyword metrics identified for the currently displayed second web page.

### BRIEF DESCRIPTION OF DRAWINGS

The foregoing and other objects, aspects, features, and advantages of the present invention will become more apparent and better understood by referring to the following description taken in conjunction with the accompanying drawings, in which:

FIG. 1A is a block diagram that depicts an embodiment of an environment for providing systems and methods described herein.

FIGS. 1B and 1C are block diagrams of computing devices that may be used in any of the embodiments of the systems and methods described herein.

FIG. 2 is a block diagram that depicts an embodiment of an augmentation server.

FIG. 3A is a flow diagram of an embodiment of a method of producing augmented content.

FIG. 3B is a flow diagram of an embodiment of a method of providing augmented content to users.

FIG. 3C is a flow diagram of an embodiment of a process of operation of advertisement and client code.

FIGS. 4A through 4E are screenshots illustrating a web page, its corresponding augmented web page, and a viewer's user experience interacting with the augmented web page according to one embodiment of the present disclosure.

FIG. 5A is block diagram of an embodiment of an ad server platform and platform services.

FIG. 5B is a diagram of an embodiment of stages of a request from a client for platform services.

FIG. 5C is a diagram of an embodiment of contextual targeting.

FIG. 5D is a diagram of another embodiment of contextual targeting.

FIG. 5E is a diagram of an embodiment of contextual and behavioral targeting.

FIG. 5F is a diagram of another embodiment of contextual and behavioral targeting.

FIG. 5G is a diagram of another embodiment of contextual and behavioral targeting.

FIG. 5G is a diagram of an embodiment of campaign selection engine.

FIG. 5I is block diagram of an embodiment of a system to provide augmented content for a keyword on a web page.

FIG. 5J is a diagrammatic view of an embodiment of augmented content.

FIG. 5K is a flow diagram of an embodiment of a method for delivering augmented content for a keyword on a web page.

FIG. 6A is a diagram of an embodiment of a system for using behavioral targeting to augment web page content.

FIG. 6B is a flow diagram of an embodiment of a method for using behavioral targeting to augment web page content.

FIG. 6C is flow diagram of another embodiment of a method for using behavioral targeting to augment web page content.

In the drawings, like reference numbers generally indicate identical, functionally similar, and/or structurally similar elements.

### DETAILED DESCRIPTION

For purposes of reading the description of the various embodiments below, the following descriptions of the sections of the specification and their respective contents may be helpful:
Section A describes a network and computing environment which may be useful for practicing embodiments described herein;
Section B describes embodiments of systems and methods for delivering augmented content;
Section C describes embodiments of systems and methods of an ad server platform for delivering a plurality of advertisement and augmented content services; and
Section D describes embodiments of systems and methods of using behavioral targeting to augment webpage content.

A. System and Network Environment

Some of the disclosed embodiments describe examples of a method (and corresponding system and computer program product) for augmenting files with related resources through layered augmentation. Viewers of the augmented files can access the related resources through a multi-layered dialog box. The process of providing additional resources through multilayered dialog box and the multi-layered dialog box are collectively called layered augmentation.

An embodiment of the method identifies data in a file, associates the identified data with reference data in a reference database, and stores the associations in a corresponding augmented file. A viewer of the augmented file can access resources related to a piece of augmented data through layered augmentation. When the viewer moves a pointer over the piece of augmented data (also called mouse-over), the related resources are provided in a multi-layered dialog box. The dialog box is overlaid on the augmented file approximate to the position where the mouse-over occurred. The viewer can navigate through the related resources in the dialog box without leaving the augmented file.

As described herein, a file includes any types of documents such as web pages. Augmented data, the data with integrated association in an augmented file, include any types of content such as text and image. Resources provided through layered augmentations include textual content, visual content such as images and videos, interactive controls such as dialog boxes, and services such as Internet search service and advertisement. A pointer can be any pointer device such as a mouse, a trackball, a roller, and a touchpad. For purposes of illustration, the method (and corresponding system and computer program product) is described in terms of augmenting keywords (or key phrases) in web pages and delivering related advertisements through multi-layered dialog boxes based on user interactions with the augmented keywords, even though the disclosed embodiments apply to all other types of content, files, and resources as defined above.

The figures and the following description relate to preferred embodiments by way of illustration only. Reference will now be made in detail to several embodiments, examples of which are illustrated in the accompanying figures. The figures depict embodiments of the disclosed system (or method) for purposes of illustration only. It should be noted that from the following discussion, other or alternate embodiments of the structures and methods disclosed herein will be readily recognized by one skilled in the art as viable alternatives that may be employed without departing from the principles described herein.

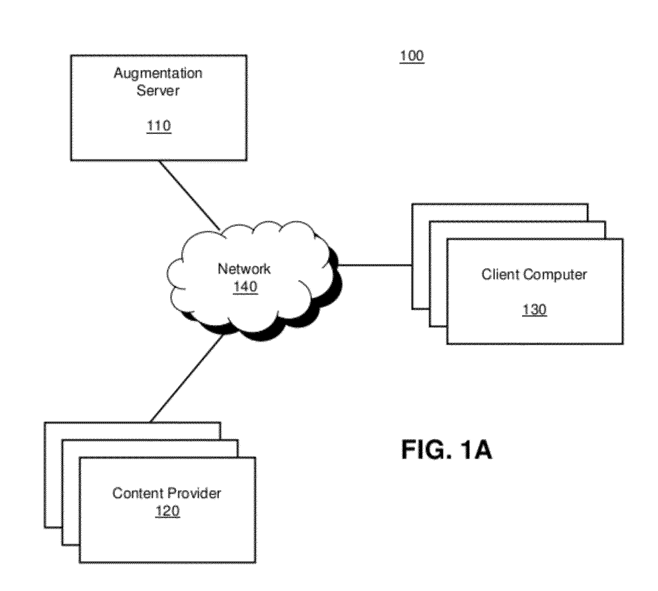

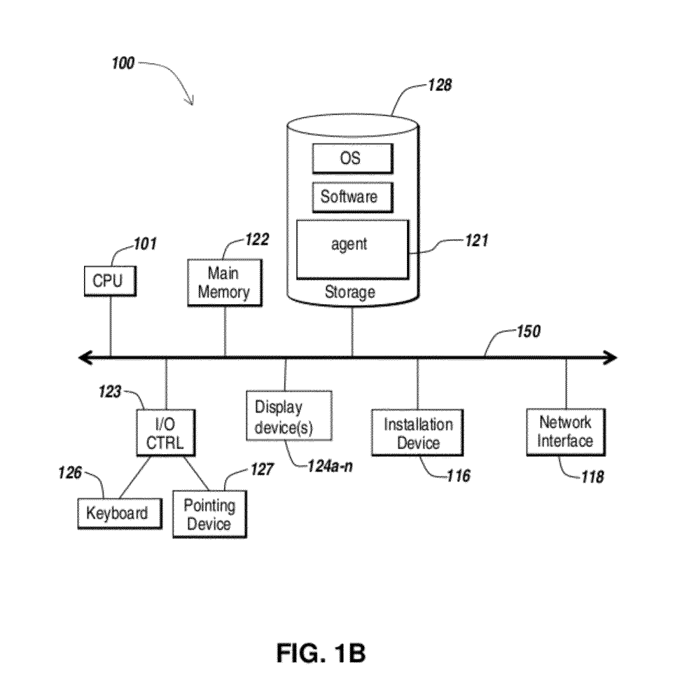

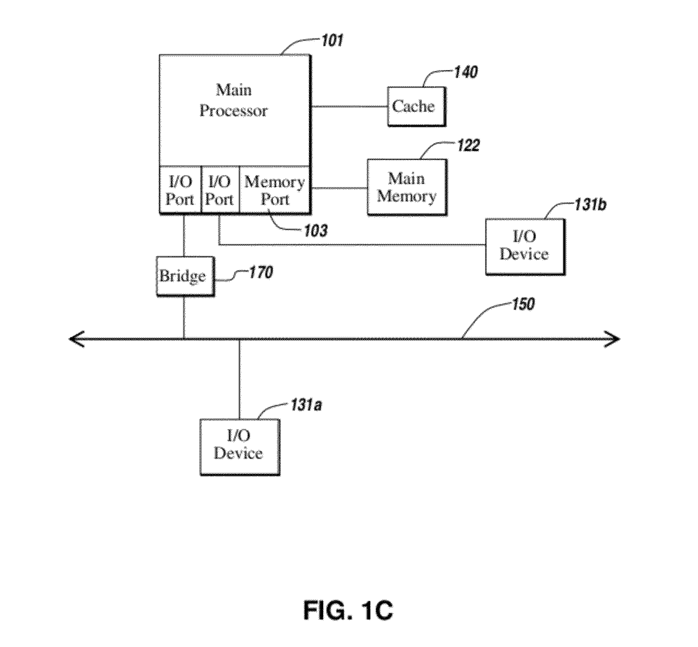

FIG. 1A illustrates an embodiment of a computing environment 100 for augmenting web pages and providing viewers of the augmented web pages with related advertisements through layered augmentation based on user interaction. As illustrated, the computing environment 100 includes an augmentation server 110, multiple content providers (or websites) 120, and one or more client computers (or user systems) 130, all of which are communicatively coupled through a network 140.

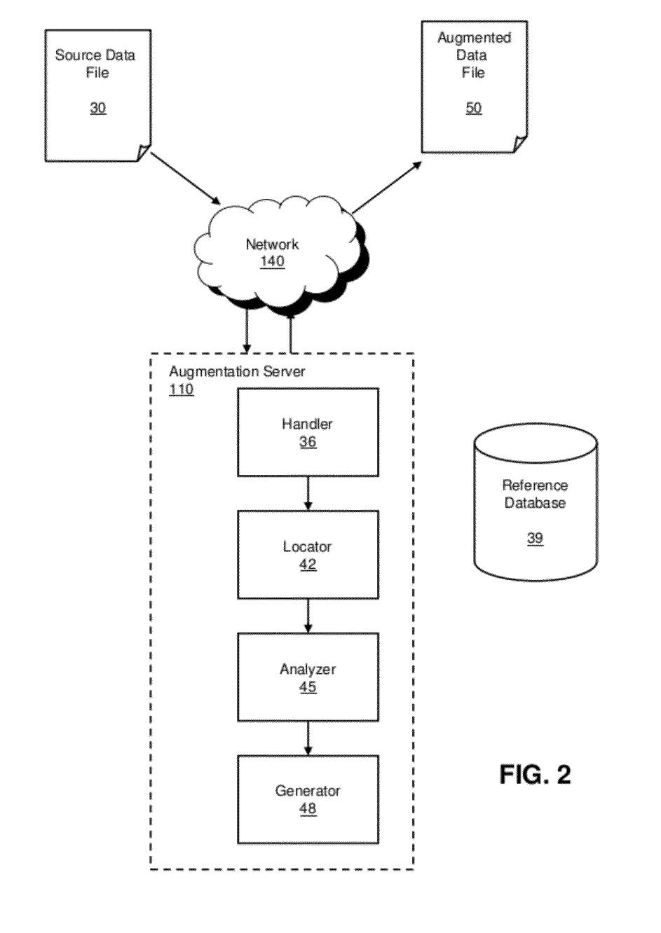

The augmentation server 110 is configured to augment keywords (or other types of content) in web pages (or other types of documents) with advertisements (or other types of resources), and deliver the advertisements based on user interaction with the augmented keywords. The augmentation server 110 retrieves web pages from the content providers 120 and augments the web pages. The augmentation server 110 augments a web page by identifying keywords in the web page, associating (or tagging) the keywords with one or more related references in a reference database, generating an augmented web page, and storing the associations in a database. When a user views an augmented web page in a client computer 130 and moves a pointer over one of the augmented keywords (hereinafter “the activated keyword”), the augmentation server 110 displays (or avails) related advertisements in the client computer 130 through a multi-layered dialog box. An example architecture of the augmentation server 110 is described in detail below with respect to FIG. 2.

The content providers 120 are entities that provide (or generate), host, publish, control, or otherwise have rights over a collection of web pages (or other types of documents). In one embodiment, the content providers 120 are web servers hosting web pages for viewers to access. The content providers 120 may provide web pages to the augmentation server 110 for layered augmentation. Alternatively, the content providers 120 may either instruct or give permission to the augmentation server 110 to retrieve all or parts of their web pages for layered augmentation.

A client 130 may comprise any personal computer (e.g., based on a microprocessor from the x86 family, the Pentium family, the 680x0 family, PowerPC, PA-RISC, MIPS families, the ARM family, the Cell family), network computer, wireless device (e.g. mobile computer, PDA, smartphone), information appliance, workstation, minicomputer, mainframe computer, telecommunications or media device that is capable of communication and that has sufficient processor power and memory capacity to perform the operations described herein. For example, the client 130 may comprise a device of the IPOD family of devices manufactured by Apple Computer of Cupertino, Calif., a PLAYSTATION 2, PLAYSTATION 3, or PERSONAL PLAYSTATION PORTABLE (PSP) device manufactured by the Sony Corporation of Tokyo, Japan, a NINTENDO DS, NINTENDO GAMEBOY, NINTENDO GAMEBOY ADVANCED, NINTENDO REVOLUTION, or NINTENDO WII device manufactured by Nintendo Co., Ltd., of Kyoto, Japan, or an XBOX or XBOX 360 device manufactured by the Microsoft Corporation of Redmond, Wash. In some embodiments, the client may include any of the Kindle family of devices sold or provided by Amazon.com.

Operating systems supported by the client 130 can include any member of the WINDOWS family of operating systems from Microsoft Corporation of Redmond, Wash., MacOS, JavaOS, various varieties of Unix (e.g., Solaris, SunOS, Linux, HP-UX, A/IX, and BSD-based distributions), any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MaC OSX, manufactured by Apple Computer of Cupertino, California; OS/2, manufactured by International Business Machines of Armonk, N.Y.; and Linux, an open source operating system distributed by, among others, Red Hat, Inc., or any type and/or form of a Unix operating system, among others.

The client computers 130 may be any type and form of client devices for users to browse web pages (or other types of documents). In one embodiment, a client computer 130 includes a pointer device (e.g., a mouse, a trackball, a roller, a touchpad, or the like), a conventional web browser (e.g., Microsoft Internet Explorer™, Mozilla Firefox™, or Apple Safari™), and can retrieve and display web pages from the content providers 120 in a conventional manner (e.g., using the HyperText Transfer Protocol). In one embodiment, the client computer 130 displays augmented keywords in an augmented web page differently than the non-augmented content. For example, the augmented keywords can be displayed in a double underline style and/or in a color distinctive from texts that are not augmented. When a user moves a pointer (e.g., mouse pointer) over (e.g., mouse-over) an augmented keyword in the augmented web page, the client computer 130 (or the utilized web browser) generates a request and transmits the request to the augmentation server 110. The augmentation server 110 receives the request and determines relevant advertisements to transmit to the client computer 130. The client computer 130 (or the utilized web browser) displays the advertisements retrieved from the augmentation server 110 in a multi-layered dialog box overlaying the augmented web page and proximate to the location where the mouse-over occurred. The multi-layered dialog box displays an advertisement and multiple clickable tabs representing the other retrieved advertisements. The viewer can select (e.g., click) a tab to request the dialog box to display the corresponding advertisement. The viewer may navigate among the multiple advertisements and interact with the advertisements without leaving the augmented web page.

The network 140 is configured to communicatively connect the augmentation server 110, the content providers 120, and the client computers 130. The network 140 may be a wired or wireless network. Examples of the network 140 include the Internet, an intranet, a WiFi network, a WiMAX network, a mobile telephone network, or a combination thereof. The network 140 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 140 may comprise a wireless link, such as an infrared channel or satellite band. The topology of the network 140 may be a bus, star, or ring network topology. The network 140 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

In one embodiment, the augmentation server 110, the content providers 120, and/or the client computers 130 are structured to include a processor, memory, storage, network interfaces, and applicable operating system and other functional software (e.g., network drivers, communication protocols). The client 120, server 110, and content providers 120 may be deployed as and/or executed on any type and form of computing device, such as a computer, network device or appliance capable of communicating on any type and form of network and performing the operations described herein.

FIGS. 1B and 1C depict block diagrams of a computing device 100 useful for practicing an embodiment of the client 130, server 110 or content provider 120. As shown in FIGS. 1B and 1C, each computing device 100 includes a central processing unit 101, and a main memory unit 122. As shown in FIG. 1B, a computing device 100 may include a visual display device 124, a keyboard 126 and/or a pointing device 127, such as a mouse. Each computing device 100 may also include additional optional elements, such as one or more input/output devices 131a-131b (generally referred to using reference numeral 131), and a cache memory 140 in communication with the central processing unit 101.

The central processing unit 101 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

Main memory unit 122 may be one or more memory chips capable of storing data and allowing any storage location to be directly accessed by the microprocessor 101, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 122 may be based on any of the above described memory chips, or any other available memory chips capable of operating as described herein. In the embodiment shown in FIG. 1B, the processor 101 communicates with main memory 122 via a system bus 150 (described in more detail below). FIG. 1C depicts an embodiment of a computing device 100 in which the processor communicates directly with main memory 122 via a memory port 103. For example, in FIG. 1B the main memory 122 may be DRAM.

FIG. 1C depicts an embodiment in which the main processor 101 communicates directly with cache memory 140 via a secondary bus, sometimes referred to as a backside bus. In other embodiments, the main processor 101 communicates with cache memory 140 using the system bus 150. Cache memory 140 typically has a faster response time than main memory 122 and is typically provided by SRAM, BSRAM, or EDRAM. In the embodiment shown in FIG. 1C, the processor 101 communicates with various I/O devices 131 via a local system bus 150. Various busses may be used to connect the central processing unit 101 to any of the I/O devices 131, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 124, the processor 101 may use an Advanced Graphics Port (AGP) to communicate with the display 124. FIG. 1C depicts an embodiment of a computer 100 in which the main processor 101 communicates directly with I/O device 131b via HyperTransport, Rapid I/O, or InfiniBand. FIG. 1C also depicts an embodiment in which local busses and direct communication are mixed: the processor 101 communicates with I/O device 131b using a local interconnect bus while communicating with I/O device 131a directly.

The computing device 100 may support any suitable installation device 116, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as any software 121 related to providing an agent, such as a safe agent, as described herein. The computing device 100 may further comprise a storage device 128, such as one or more hard disk drives or redundant arrays of independent disks, for storing an operating system and other related software, and for storing application software programs such as any program related to an agent 121 as described herein. Optionally, any of the installation devices 116 could also be used as the storage device 128. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 131a-131n may be present in the computing device 100. Input devices include keyboards, mice, trackpads, trackballs, microphones, and drawing tablets. Output devices include video displays, speakers, inkjet printers, laser printers, and dye-sublimation printers. The I/O devices 131 may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage 128 and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, California.

In some embodiments, the computing device 100 may comprise or be connected to multiple display devices 124a-124n, which each may be of the same or different type and/or form. As such, any of the I/O devices 131a-131n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 131 may be a bridge 170 between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCl/LAMP bus, a FibreChannel bus, or a Serial Attached small computer system interface bus.

A computing device 100 of the sort depicted in FIGS. 1B and 1C typically operate under the control of operating systems, which control scheduling of tasks and access to system resources. The computing device 100 can be running any operating system such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, and WINDOWS XP, all of which are manufactured by Microsoft Corporation of Redmond, Wash.; MacOS, manufactured by Apple Computer of Cupertino, California; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 100 may have different processors, operating systems, and input devices consistent with the device. For example, in one embodiment the computer 100 is a Treo 180, 270, 1060, 600 or 650 smart phone manufactured by Palm, Inc. In this embodiment, the Treo smart phone is operated under the control of the PalmOS operating system and includes a stylus input device as well as a five-way navigator device. In some embodiments, the computing device may include any type and form of wireless reading device, such as any Kindle device manufactured by Amazon.com Inc. of Seattle, Wash. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

B. Systems and Methods for Providing Augmented Content

FIG. 2 is a block diagram illustrating one example architecture of the augmentation server 110 as described above with respect to FIG. 1. As illustrated, the augmentation server 110 includes a handler 36, a locator 42, an analyzer 45, a generator 48, and a reference database 39. The components 36 through 45 may include a software or firmware instruction that can be stored within a tangible computer readable medium (e.g., magnetic disk drive, optical disk or solid state memory such as flash memory, or random-access memory) and executed by a processor or equivalent electrical circuits, state machines, microcode, or the like.

A source data file 30 (e.g., a web page) resides on a server (e.g., a content provider 120) on a network 140 (e.g., the Internet). The handler 36 retrieves the source data file 30 for augmentation by the augmentation server 110. The locator 42 examines the retrieved source data file 30 for comparison to data in the reference database 39. In one embodiment, the locator 42 analyzes content of the source data file 30 for keywords, searches corresponding reference data in the reference database 39, and provides the keywords and the corresponding reference data to the analyzer 45. In an alternate embodiment, rather than analyzing the source data file 30 for keywords, the locator 42 retrieves a list of keywords from the reference database 39 and enumerates through the textual content of the source data file 30 for matches.

The analyzer 45 creates associations between the keywords and the corresponding reference data found by the locator 42. The generator 48 generates an augmented data file 50 by embedding the associations created by the analyzer 45 in the source data file 30. The generator 48 embeds associations by generating intelligent tags for the keywords, and augmenting the keywords with the intelligent tags. In one embodiment, an intelligent tag is an alphabetic and/or numeric string that identifies its associated keywords, and/or reference data, and optionally includes an unique identification number (hereinafter called the association ID). The generator 48 inserts the generated intelligent tags into the source data file 30 to generate the augmented data file 50. Web pages with the integrated intelligent tags are called augmented web pages. Keywords with the integrated intelligent tags are called augmented keywords. The generator 48 also stores the identified keywords and/or the associations in a database for later references.

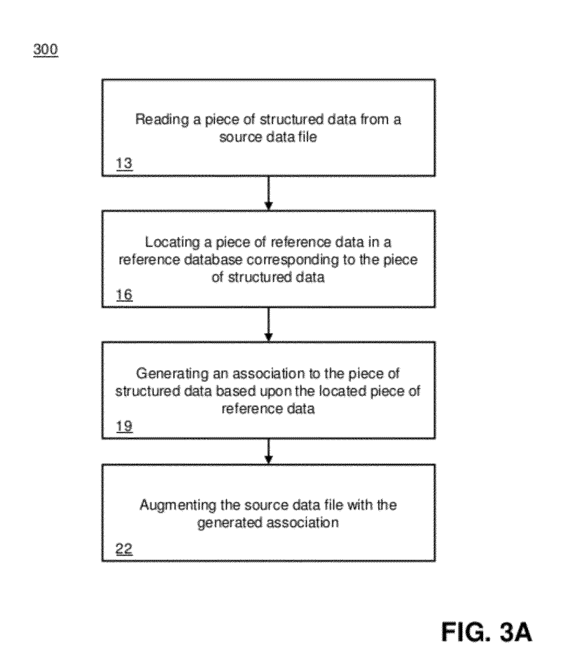

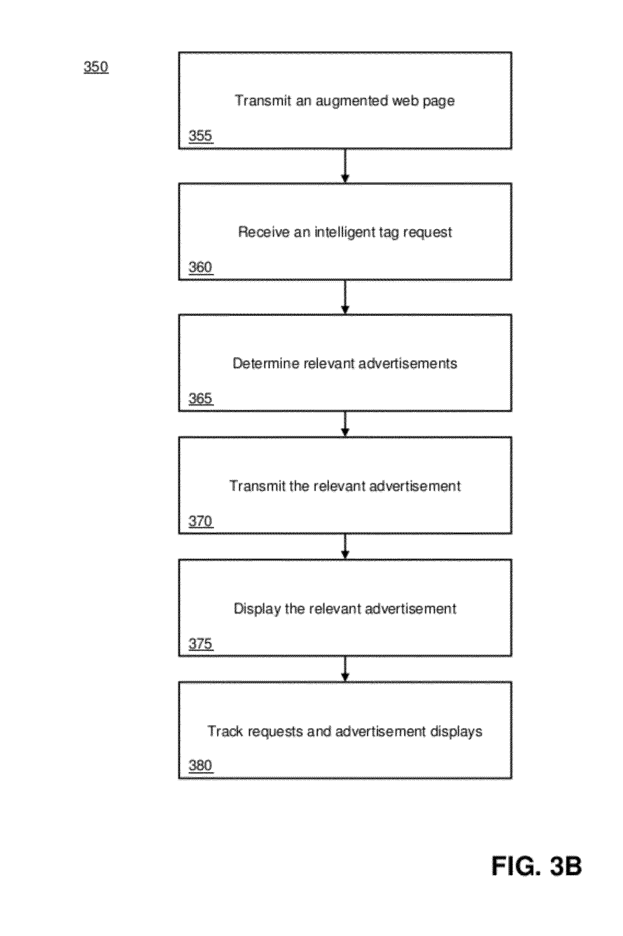

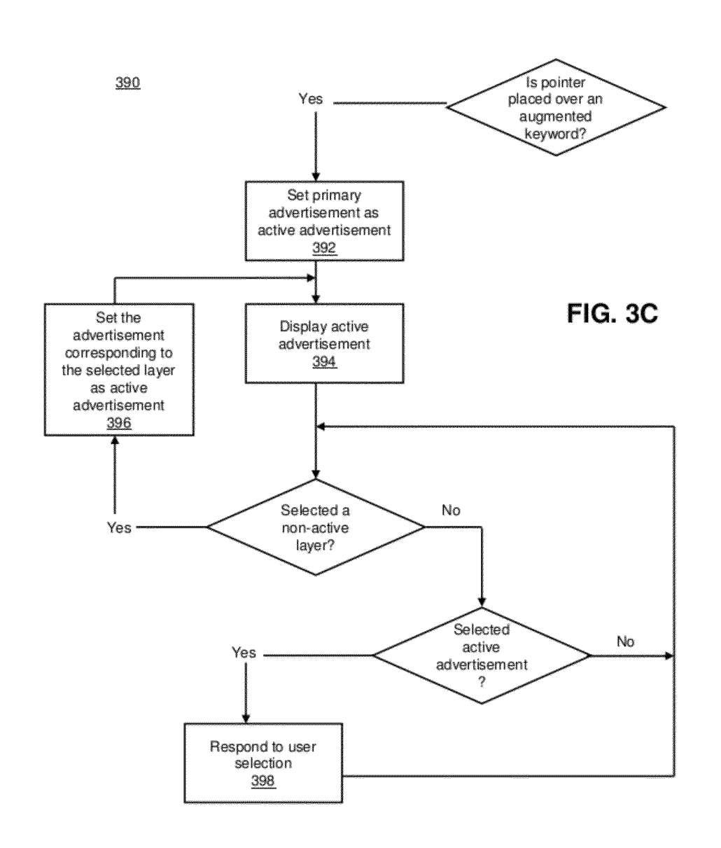

The resulting augmented data file 50 is returned to the handler 36 to reside at a Universal Resource Locator (URL) address on the network 140 (e.g., at the content provider 120 from which the source data file 30 is retrieved). In one embodiment, the handler 36 also receives requests (or signals) from client computers 130 indicating user interactions with the augmented data file, and transmits to the client computers 130 related advertisements for display through layered augmentation. Layered augmentation is described in detail below with respect to FIGS. 3A through 3C. The handler 36 retrieves the activated keywords (e.g., from the requests), and determines one or more relevant advertisements from an advertising database (not shown) that matches the keywords and/or the associated reference data. In one embodiment, rather than transmitting the related advertisements, the handler 36 transmits addresses (e.g., URLs) of the relevant advertisements to the requesting client computer 130. The client computer 130 resolves the addresses to retrieve the advertisements.

The reference database 39 stores reference data such as types of advertisements (e.g., television advertisements), categories of advertisements (e.g., storage rental, home equity loan), and/or information about specific advertisements (e.g., associated keywords, format information, price the advertiser is willing to pay, and URL of the advertisement). The reference database 39 may be a relational database or any other type of database that stores the data, such as a flat file. In one embodiment, the reference database 39 is a web enabled reference database supporting remote calls through the Internet to the reference database 39.

The components of the augmentation server 110 can reside on a single computer system or several computer systems located close by or remotely from each other. For example, the analyzer 45 and the generator 48 may reside on separate web servers, and the reference database 39 may be located in a dedicated database server. In addition, any of the components or sub-components may be executed in one or multiple computer systems.

Web pages (or web browsers) can provide additional information to viewers. For example, when a user places a mouse over a link label of a hyperlink, a web browser displays the associated destination URL (e.g., on a status bar of the web browser). As another example, when a user places a pointer over a keyword, the web browser may generate a pop-up dialog box, and display relevant information (e.g., an explanation of the keyword). The process of providing additional information to web page viewers is called augmentation.

A keyword (or phrase) often has multiple aspects of related information, each having multiple aspects of related information. For example, the key phrase “digital camera” is related to its history, underlying technology, and available products and services. A specific product related to digital camera has related information such as product description, customer review, and competing products. Usually only one aspect of the related information is provided through augmentation due to limited display space.

Multiple aspects of related information can be arranged and provided to viewers through layered augmentation. Each aspect of related information can be assigned to one specific layer of the layered augmentation. Viewers can navigate among the multiple aspects of related information by accessing the different layers of the layered augmentation without leaving the web page. For example, the augmented information can be displayed in a multi-layered dialog box. A viewer can navigate among different layers by selecting associated tabs displayed in the dialog box in which each tab is associated with a layer. Alternatively, the multiple layers may be stacked in a manner similar to windows in Microsoft Windows™ Operating System. The stacked layers may be arranged in a horizontal, vertical, or cascade style, showing a small exposed portion of each layer, such as a title area or a corner area. Navigation between each layer in the stack can be through selection of that small exposed portion of the layer within the stack. The process of providing additional information (or resources) through multi-layered dialog box and the multi-layered dialog box are collectively called layered augmentation.

FIGS. 3A through 3C are flowcharts collectively illustrating an example process (or method) for augmenting web pages and providing viewers of augmented web pages with related advertisements through layered augmentation. In one embodiment, the illustrated method (or either of its sub-methods 300, 350, and 390) is implemented in a computing environment such as the computing environment 100. One or more portions of the method may be implemented in embodiments of hardware and/or software or combinations thereof.

By way of example, the illustrated method may be embodied through instructions for performing the actions described herein and such instrumentations can be stored within a tangible computer readable medium and are executable by a processor. Alternatively (or additionally), the illustrated method may be implemented in modules like those in the augmentation server 110 described above with respect to FIG. 2 and/or other entities such as the content providers 120 and/or the client computers 130. Furthermore, those of skill in the art will recognize that other embodiments can perform the steps of the illustrated method in different order. Moreover, other embodiments can include different and/or additional steps than the ones described here.

FIG. 3A illustrates an example process (or method) 300 for augmenting web pages. As illustrated in FIG. 3A with reference to components of the augmentation server 110 in FIG. 2, at an appropriate starting terminus 10, the method 300 begins by reading a piece of structured data from a source data file 30 at a block 13 (e.g., through the handler 36). The source data file 30 may be one designated by an input uniform resource locator (URL) address or by any suitable means to designate a resource. Upon opening the source data file 30, the method 300 may optionally identify the type of content on the page with a content identifier such as a MIME header (e.g., through the locator 42). In one embodiment of the invention, the method 300 merely searches for the presence of a piece of reference data (e.g., through the locator 42), either informed by the content identifier or by simply searching an occurrence of a piece of well structured data (e.g., a keyword) within the source data file. In addition, once the source data file 30 is open, the method 300 has its content available for comparison to reference data in the reference database 39. Other methods and examples to read a piece of structured data from the source data file are described in U.S. application Ser. No. 12/033,539, filed on Feb. 19, 2008, the content of which is incorporated by reference in its entirety.

At a block 16, the method 300 locates one or multiple pieces of reference data in the reference database 39 corresponding to the piece of structured data read in the source data file 30 (e.g., through the locator 42). In one embodiment, the locator 42 searches for reference data in the reference database 39 that match the piece of structured data by making function calls to the reference database 39. In one embodiment, the structured data are keywords, and the reference data also contain keywords.

Keywords are a facile and efficient means of generating layered augmentation. In addition to or instead of using keywords, one embodiment uses a “fuzzy expert” or a neural network analysis of the source data file 30, such as by a natural language search of the source data file 30 to generate a distinct identifier for the content in the source data file 30. One advantage of a natural language search is the ability to better place content in context making links more contextually appropriate, for instance, security might relate to security of a physical plant such as security of a residence in one source data file 30 in one context and security of a website in another. In one embodiment, the method 300 determines a context of the keywords and/or the source data file 30 based on statistical modeling (e.g., through the locator 42). For example, a context can be assigned a pre-defined set of terms which acts as a fingerprint for the context (hereinafter called context fingerprint). The locator 42 can compare the context fingerprints associated with a collection of contexts with the terms within the source data file 30 to determine a percentage match for each context in the collection. Where a high percentage match is achieved (e.g., exceeding a pre-defined percentage match threshold), the locator 42 determines that the associated context is the context for the source data file 30. Alternatively or in conjunction, the locator 42 may determine the context associated with the highest percentage match as the context for the source data file 30. The context can be used to locate corresponding reference data and/or related resources.

At a block 19, the method 300 generates an association to the piece of structured data based upon the located matching reference data (e.g., through the analyzer 45). In one embodiment, a piece of reference data includes an identifier such as a keyword, a context, a unique identification number, and/or associated URL address(es) of intended destination resource(s) based upon the occurrence of the corresponding keywords in the source data file 30. Generating an association means to associate the piece of structured data located in the source data file 30 with the located reference data in the reference database 39. The generated association might optionally include additional identification codes such as an association ID. The method 300 then augments the original source data file 30 with the generated association at a block 22 to generate an augmented data file 50 (e.g., through the generator 48).

In one embodiment, the method 300 expresses the association as intelligent tags (e.g., through the generator 48). The method 300 generates intelligent tags for the located keywords and tags the keywords with the generated intelligent tags. The intelligent tags contain information about the associated keywords such as the keyword and related context, and information about the associated reference data such as IDs that uniquely identify the reference data in the reference database 39. For example, the intelligent tags may contain requirement (or preference) information about advertisements (or other types of resources) to be associated with the keyword, such as types of advertisements and a minimum advertisement fee. In one embodiment, the intelligent tags also format the augmented keywords differently than the other textual content in the augmented web pages. Having generated the augmented data file 50, the method 300 then terminates at a block 25.

In one embodiment, the augmentation server 110 (or the content providers 120) also augments the web pages by including computer code (hereinafter called client code) to monitor and report viewers' interactions with the augmented keywords. The computer code can be in any computer language, such as JavaScript. Additional functions of the client code are described in detail below with respect to FIGS. 3B and 3C.

The augmented data file 50 can be delivered (or transmitted) to client computers 130 for display through a web browser to viewers to provide related resources through layered augmentation. The delivery of the augmented data file 50 and the process to provide layered augmentation is described in detail below with respect to FIGS. 3B and 3C. For purpose of illustration, the method is described in terms of web pages augmented with advertisements, even though the disclosed embodiments apply to other types of augmented data file and resources.

Referring now to FIG. 3B, a flowchart illustrating an example process (or method) 350 for providing layered augmentation to viewers of augmented web pages. As illustrated, the method 350 transmits 355 an augmented web page to a client computer. For example, a user of the client computer 130 may enter the URL of an augmented web page (or the corresponding original web page) in the address bar of a conventional web browser (e.g., Microsoft Internet Explorer™, Mozilla Firefox™, or Apple Safari™). The web browser of the client computer 130 (hereinafter called the client web browser) resolves the URL and transmits a request for the web page to a corresponding content provider. Responding to the request, the content provider transmits 355 the augmented web page to the client web browser for display. In one embodiment, the client web browser displays augmented keywords in a double underline style and/or in a color distinctive from text that is not augmented in the augmented web page.

The method 350 receives 360 an intelligent tag request from the client computer 130. As described above with respect to FIG. 3A, the augmented web page contains client code that monitors user interactions with augmented keywords. In one embodiment, if the user moves a pointer (e.g., a pointer controlled by a mouse, navigation button, or touchpad) over (a mouse-over) an augmented keyword (the activated keyword), the client code (which may be integrated with the web browser, for example, as a plug-in applet) generates an intelligent tag request and transmits the request to the augmentation server 110. The request indicates the mouse-over user activity to the augmentation server 110. The request may contain information that uniquely identifies the activated keyword (e.g., an association ID), and/or other information such as the activated keyword itself.

The method 350 determines 365 advertisements relevant to the activated keyword for the received request based on the keyword and/or the associated reference data. In one embodiment, the augmentation server 110 extracts the keyword and/or related context from the request, retrieves the associated reference data from the reference database 39, and determines 365 the relevant advertisements by searching in an advertisement database using the keyword and/or requirements set forth in the associated reference data (e.g., advertisement category, context, fee requirements, etc.).

In one embodiment, the method 350 determines 365 the advertisements that match the best (e.g., matching the activated keyword and/or satisfies the most number of reference requirements) as the relevant advertisements. In another embodiment, the method 350 determines 365 relevant advertisements based on a context of the augmented web page and/or the activated keyword. For example, for a key phrase “digital camera” in an article about digital camera, the method 350 may determines the following resources as relevant: a product review of a digital camera in CNET.com, a collection of user reviews at Buy.com, and a selection of similar digital cameras. The context can be determined when the activated keyword is identified in method 300.

In one embodiment, the method 350 determines a sequence for the related advertisements. The top advertisement in the sequence (also called the default advertisement or the primary advertisement) is the advertisement being displayed on the top layer of the layered augmentation. The lower ranked advertisements (also called secondary advertisements) are made available on lower layers of the layered augmentation. In one embodiment, the method 350 uses a bidding system to determine related advertisements sequence. For example, for a key phrase “digital camera,” there may be multiple related advertisements (e.g., advertisements for different brands or models of digital cameras), each having a bid (or budget or cost) for the key phrase. The method 350 may determine a sequence of the advertisements based on their bids, the one with the highest bid ranked the highest and so on.

In another embodiment, the method 350 may determine the sequence of multiple advertisements based on factors other than bidding prices. For example, the method may consider factors such as relationships among the multiple advertisements (e.g., prioritizing video advertisements over text ones), prior user interactions with the advertisements (e.g., prioritizing advertisements with higher interacting rate), and contexts of the augmented keyword (e.g., prioritizing advertisements from retailers or service providers having branches near a geographical context of the keyword and/or the augmented web page, or geographic locations of a substantial portion of viewers of the web page).

Further, specific sequences may be set for specific keywords and/or parties (e.g., content providers, advertisers, users). For example, if the keyword(s) is a music artist (or band, album) name, the method 350 may make available his songs (e.g., playback through an embedded music player) on the top layer and other resources on lower layers. As another example, if the keyword(s) is a location name (e.g., Yellowstone National Park), the method 350 may make available the relevant map (e.g., MapQuest™ Map) on the top layer. As noted above, the resources made available through the layered augmentation need not to be advertisements and can be related contents such as related articles, videos, images, music, to name only a few. For example, a content provider may specify that the layered augmentations in its web pages make available a set of links to its other relevant web pages (e.g., within the same website) where the keyword(s) being augmented is cross-indexed.

In one embodiment, viewers can set their preferences to determine a preferred sequence for the layered augmentation. For example, a viewer may prefer video advertisements while another may disfavor them (e.g., due to bandwidth constrains at receiving device). As a result, the method 350 may place video advertisements higher on a sequence for the first viewer, while not consider video advertisements for augmentation for the second viewer. Viewer preferences can be stored in a database such as the reference database 39 along with other viewer related data (e.g., profile data).

The method 350 transmits 370 the relevant advertisements to the client computer 130 for display. In one embodiment, the method 350 retrieves the advertisements from an advertisement database, and transmits 370 them to the client web browser (or the client computer) for display. Alternatively, the method 350 may transmit references of the advertisements (e.g., their URLs) to the client web browser for retrieval.

In one embodiment, the method 350 generates computer code (hereinafter called the advertisement code) to facilitate user interaction with the advertisements. Similar to the client code, the advertisement code can be in any computer language, such as JavaScript. The advertisement code may display the relevant advertisements in a multi-layered dialog box (or popup box) when the viewer moves a pointer over the activated keyword. The method 350 transmits the generated advertisement code along with the related advertisements to the client web browser. In one embodiment, the advertisement code is a part of the client code, and is integrated in the augmented web page when the page is generated

The client web browser displays 375 the relevant advertisements in a layered dialog box proximate to the activated keywords (or the position where the mouse-over is occurring) as an in-page overlay. In one embodiment, the client web browser utilizes the advertisement code to display the advertisements in a multi-layered dialog box. The advertisements are displayed according to their sequence. In one embodiment, only the top advertisement is displayed and the lower ranked advertisements are represented by selectable tabs. An example process of the operation of the advertisement code and the client code is described in detail below with respect to FIG. 3C.

Referring now to FIG. 3C, a flowchart illustrating an example process (or method) 390 of the client code and/or the advertisement code. As illustrated, the method 390 determines whether a pointer is positioned over an augmented keyword (the activated keyword), and if so, sets 392 the primary advertisement as the active advertisement, and displays 394 the active advertisement in a multi-layered dialog box overlaying the augmented web page in a position proximate to the activated keyword or the mouse-over. The multi-layered dialog box also displays multiple selectable (e.g., clickable) tabs representing the lower layers. The viewer can select a tab to request the multi-layered dialog box to display the corresponding layer. If the user selected a tab, the method 390 sets 396 the advertisement corresponding to the selected layer as the active advertisement and displays 394 it in place of the previously displayed advertisement.

The viewer can also interact with the currently displayed advertisement by selecting the advertisement. If the viewer selects the advertisement, the method 390 responds 398 to the user selection based on the nature of the user selection and the configuration of the advertisement. For example, if the user clicks on the active advertisement, the method 390 redirects the web browser to a web page related to the active advertisement. Alternatively, if the user drags a scrollbar displayed on the dialog box, the method displays different portions of the active advertisement as the user drags along the scrollbar. In one embodiment, if the viewer moves the pointer away from the activated keyword and/or the multi-layered dialog box for an extended period of time, the method 390 hides the dialog box.

Referring back to FIG. 3B, in one embodiment, rather than displaying multiple advertisements, the method 350 displays multiple aspects (or portions) of the same advertisement in the multi-layered dialog box. For example, the multi-layered dialog box may display an image and brief description of a product, and present two tabs, one for user reviews and the other for playback of a television advertisement of the product. The viewer may interact with the advertisement through the multi-layered dialog box without having to navigate away from and otherwise leave the current web page the viewer is interacting with in the web browser. For example, if the advertisement contains video, the multi-layered dialog box may overlay the video with video controls (e.g., forward, rewind, play/pause, volume, etc.). The multi-layered dialog box may also provide functional resources such as web searches, enabling viewers to conduct web searches and/or review search results without leaving the augmented web page.

The method 350 tracks 380 the received requests, the advertisements displays, and/or the user's interactions with the advertisements. These activities may be logged in a database (e.g., the reference database 39) or reported to another device or person (e.g., via electronic mail).

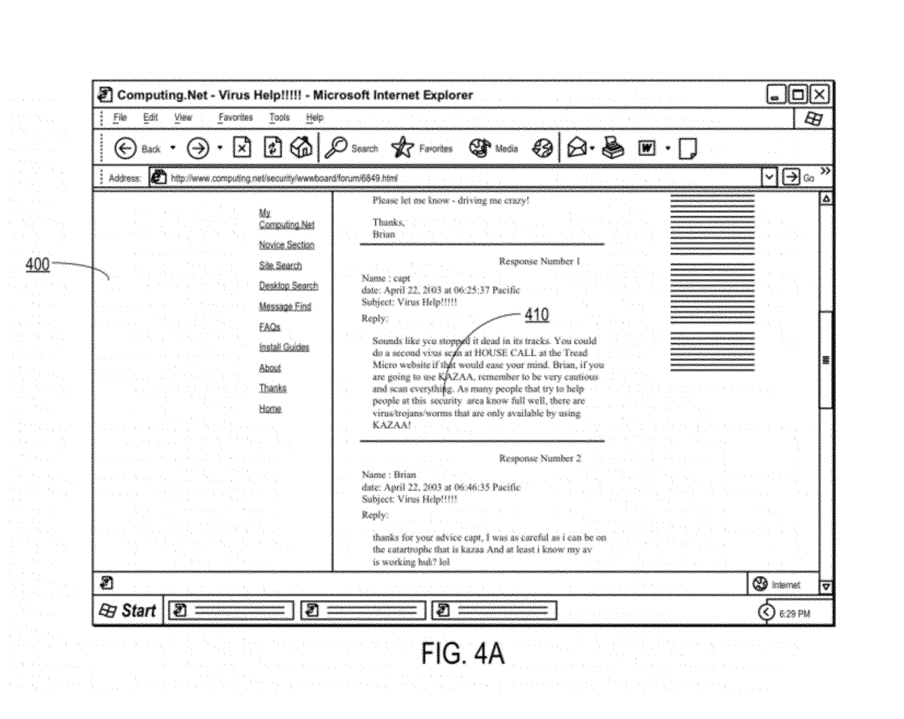

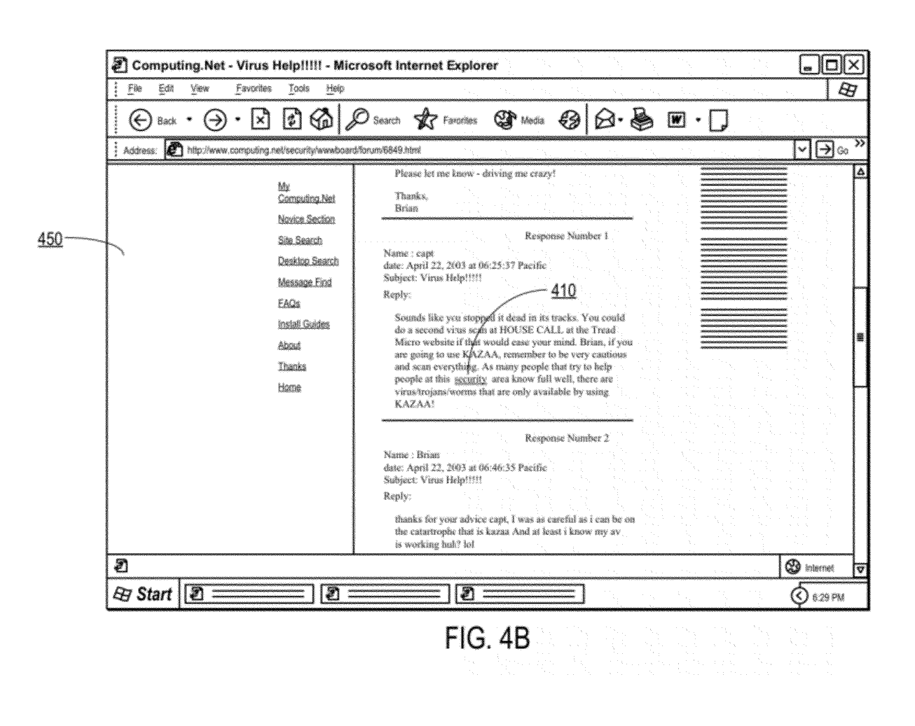

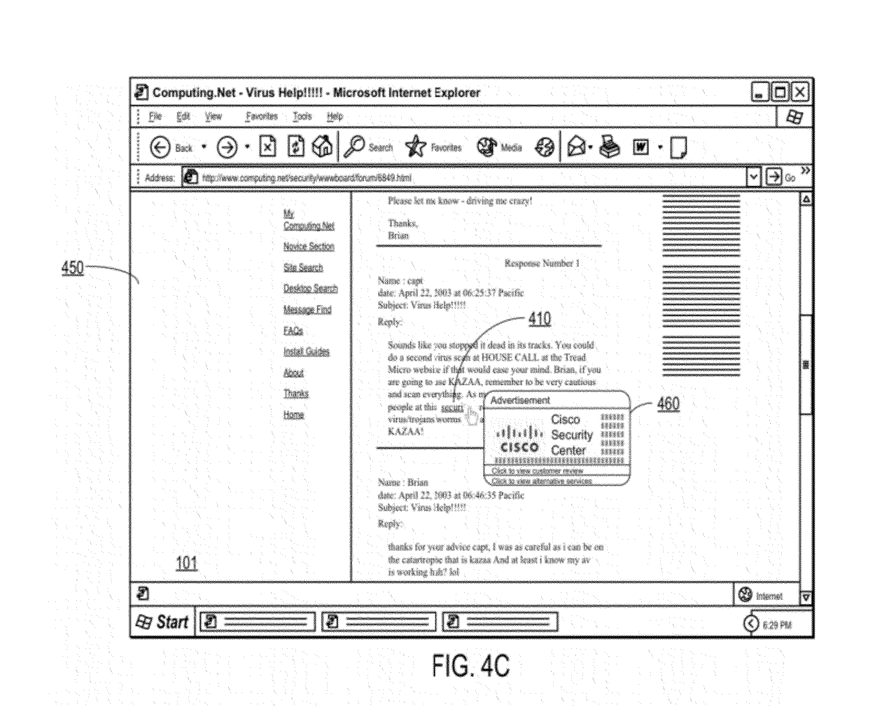

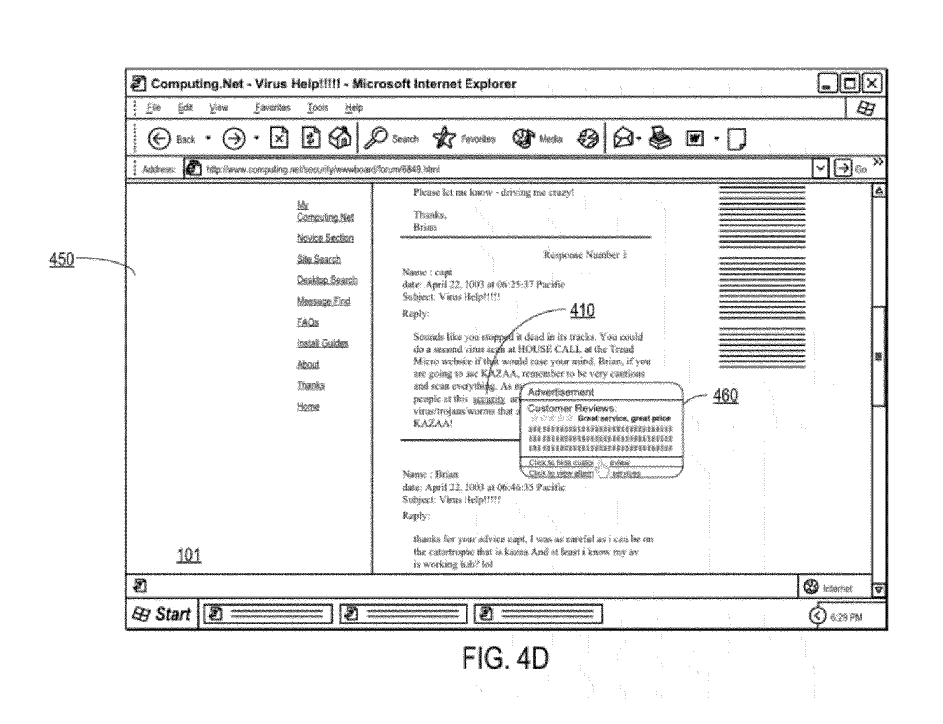

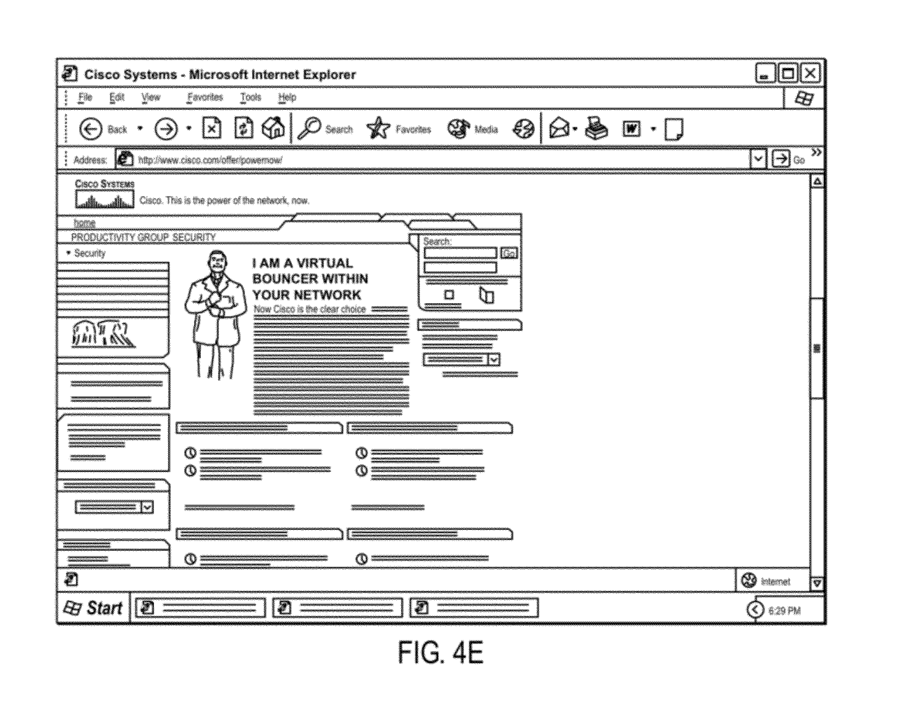

The methods described above with respect to FIGS. 3A through 3C are illustrated below in an example together with accompanying screenshots in FIGS. 4A through 4E. Initially, the augmentation server 110 retrieves a web page 400 for augmentation. The web page 400 may contain textual content of any subject. FIG. 4A shows an example of the web page 400 as displayed in Microsoft Internet Explorer™. As shown in FIG. 4A, the web page 400 is retrieved from website www.computing.net and contains a paragraph about computer virus.

The augmentation server 110 reads 13 the web page 400 for keywords. The augmentation server 110 identifies the keyword “security” 410 for layered augmentation. The augmentation server 110 locates 16 a piece of reference data matching the keyword “security” 410 and determines a context of computer security for the keyword 410. The piece of reference data includes an advertisement category for computer security services. The augmentation server 110 generates 19 an association of the keyword “security” 410 and the located piece of reference data.

The augmentation server 110 augments 22 the web page 400 by generating an intelligent tag encoding the generated association, and integrating the intelligent tag in an augmented web page 450. The augmentation server 110 also includes in the augmented web page 450 JavaScript code (client code) that captures user interactions with the augmented keyword 410.

A web browser running on a client computer 130 retrieves the augmented web page 450 and displays it to a user (e.g., responding to the user entering an URL of the web page 400 or 450 in the address bar of the web browser). FIG. 4B illustrates a screenshot of the augmented web page 450 as displayed on an Internet Explorer™ web browser after it is retrieved by the browser. It is noted that in FIG. 4B the augmented keyword 410 is displayed in a double underline style to distinguish from conventional hyperlinks that are single underlined.

Subsequently, the user may move a pointer (e.g., controlled by a mouse, stylus, or touchpad) over the double underlined augmented keyword 410 (the activated augmented keyword). This user action is also referred to as a mouse-over. Detecting the mouse-over, the embedded JavaScript code (the client code) in the augmented web page 450 (or the web browser) generates an intelligent tag request that uniquely identifies the activated augmented keyword 410 and/or the related context, and transmits the request to the augmentation server 110. The augmentation server 110 receives 360 the request, retrieves stored association of the keyword 410, and determines 365 relevant advertisements by searching for advertisements corresponding to the keyword 410 and/or the related context in an advertising database. In the present example, the augmentation server 110 determines 365 that an advertisement for Cisco security center is the relevant advertisement associated with the augmented keyword 410.

The augmentation server 110 determines a sequence of various parts of the Cisco advertisement and/or other relevant advertisements. In the present example, the augmentation server 110 determines that a description of the Cisco security center ranks top in the sequence, followed by its customer reviews, and a list of competing services.

The augmentation server 110 transmits 370 the related advertisement(s) back to the web browser for display. The augmentation server 110 also transmits JavaScript code (advertisement code) that enables layered representation of the transmitted advertisements.

The web browser (or the advertisement code) displays 375 the received advertisement(s) as an overlay in a multi-layered dialog box in proximity to the keyword 410 or the location where the mouse-over occurred. As illustrated in FIG. 4C, the user has moved a mouse pointer over the keyword 410. As a result, the web browser receives advertisements related to the keyword “security” 410 and displays them in a multi-layered dialog box 460 proximate to the pointer.

As illustrated, the multi-layered dialog box 460 displays an advertisement about CISCO security center. On the bottom of the multi-layered dialog box 460 are two tabs labeled “Click to view customer review” and “Click to view alternative services,” respectively. Note that this is consistent with the sequence of the advertisements (and/or advertisement portions) determined by the augmentation server 110. The user can navigate the advertisements within the multi-layered dialog box 460 by clicking the labeled tabs. The user can also visit the corresponding advertiser's web page by clicking the advertisement. While the user navigates within the multi-layered dialog box 460, the augmented web page 450 remains as the current web page displayed in the client web browser. The user can quickly resume browsing the rest of the augmented web page 450.

As illustrated in FIG. 4D, when the user clicks (or mouse-over) the tab labeled “Click to view customer review,” the multi-layered dialog box 460 displays customer reviews for Cisco security center. It is noted that the label on the tab representing customer review changes to “Click to hide customer review.” The user can click the tab to resume viewing the previous advertisement for Cisco security center.

As illustrated in FIG. 4E, when the user clicks the Cisco security center advertisement, the advertisement code redirects the client web browser to the advertiser's web page, in this case a web page related to Cisco security center.

C. Systems and Methods of an Ad Server Platform

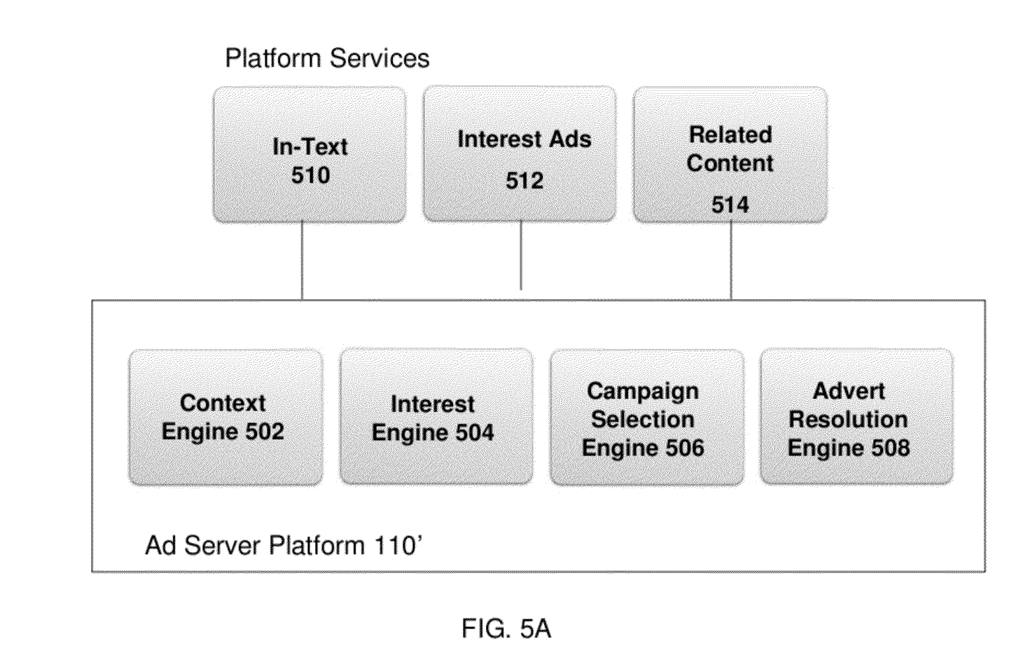

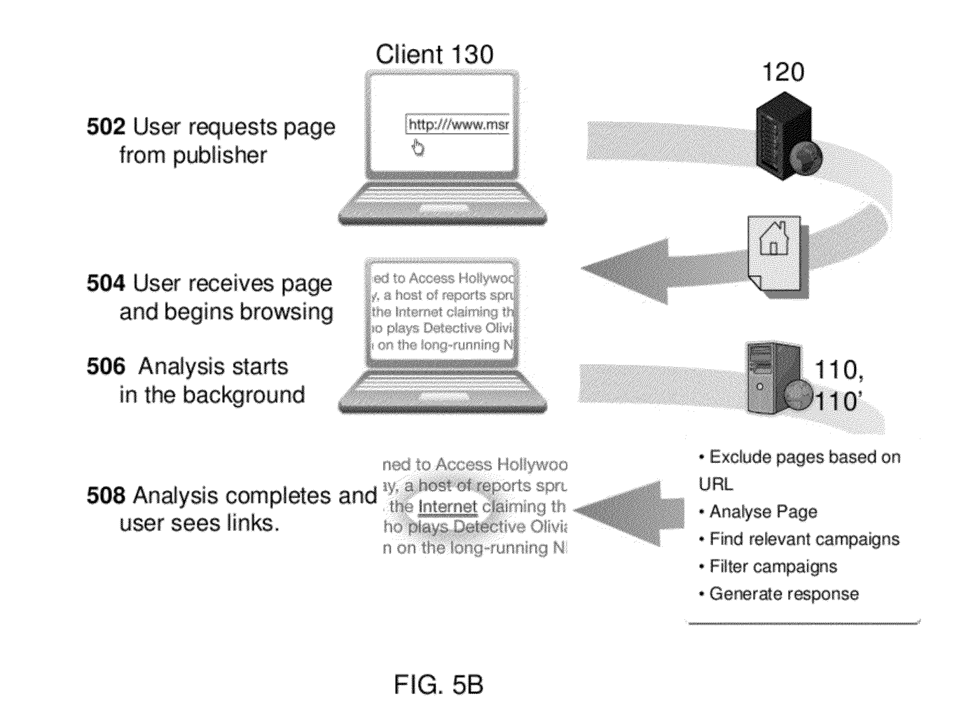

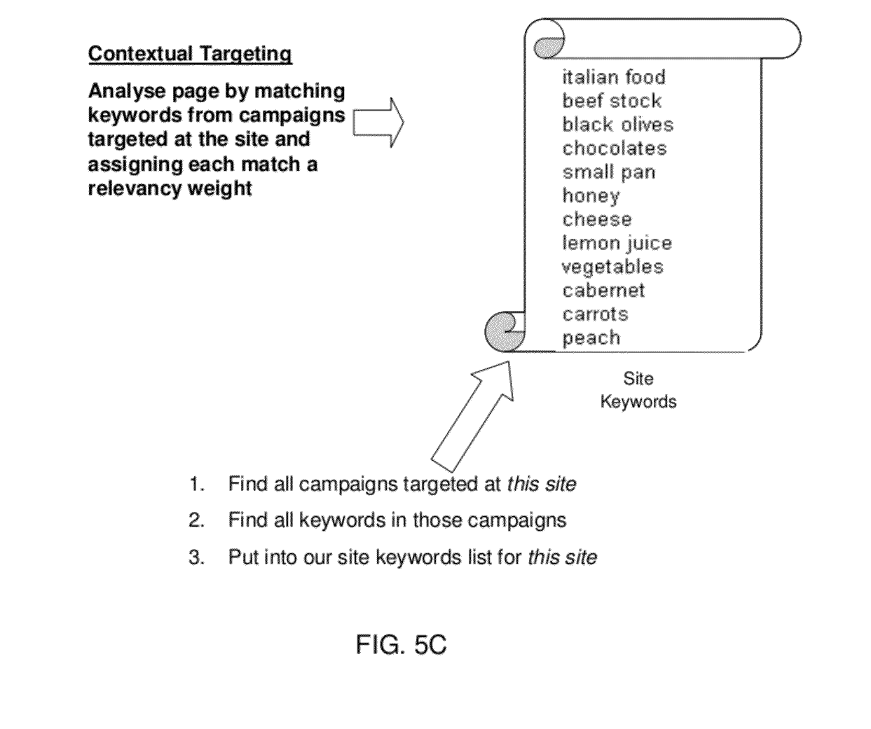

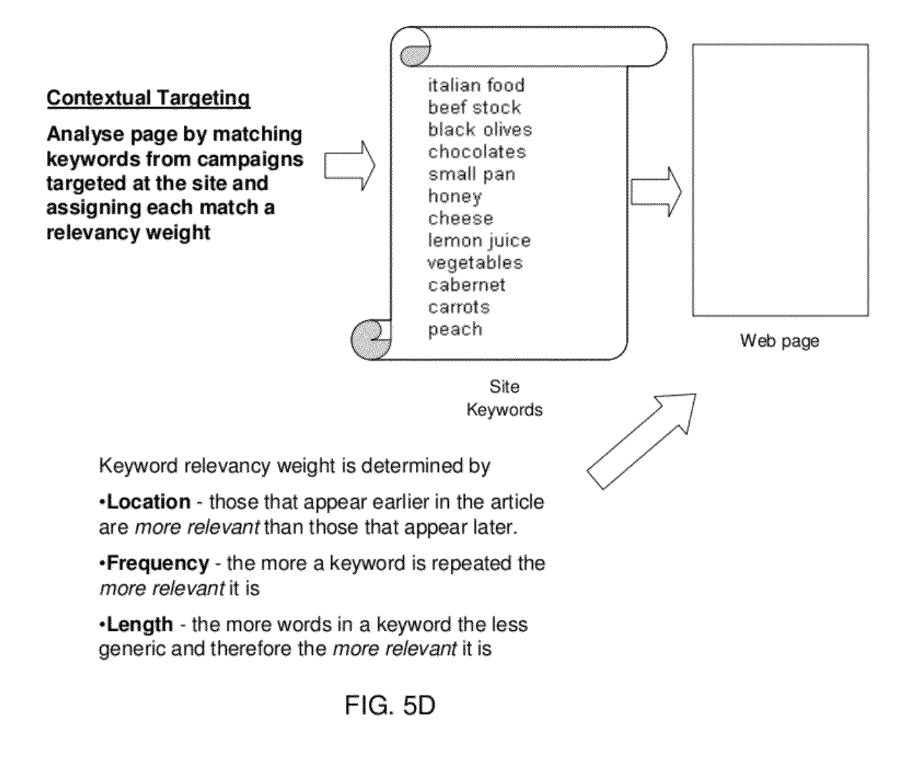

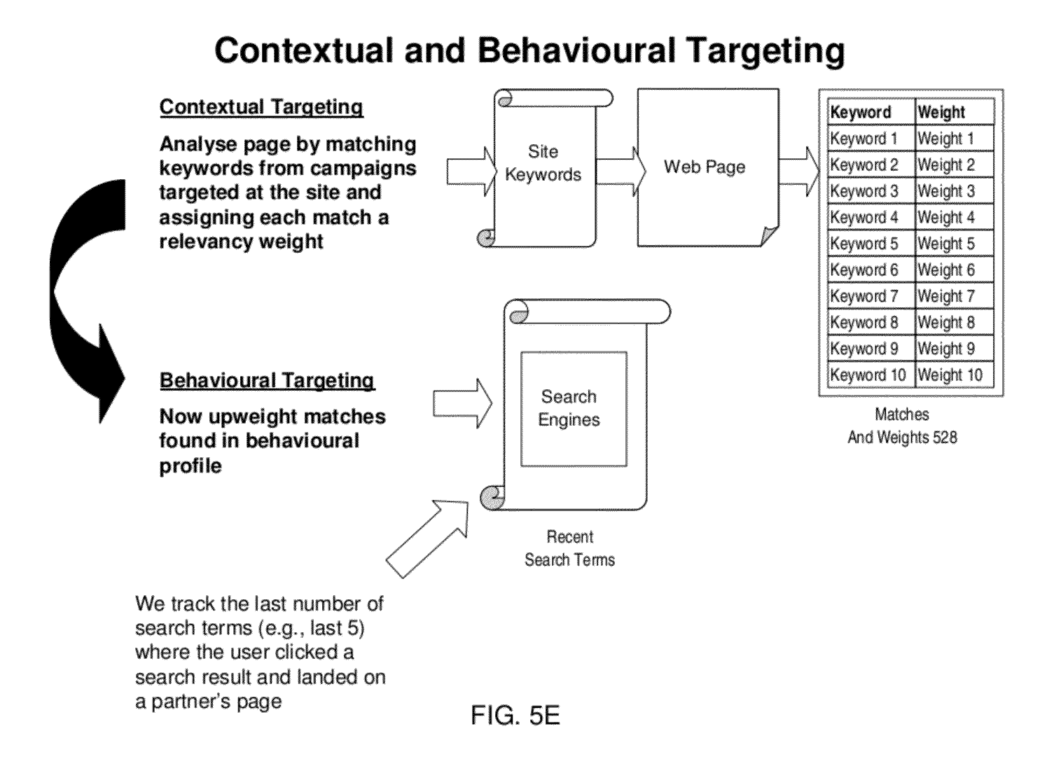

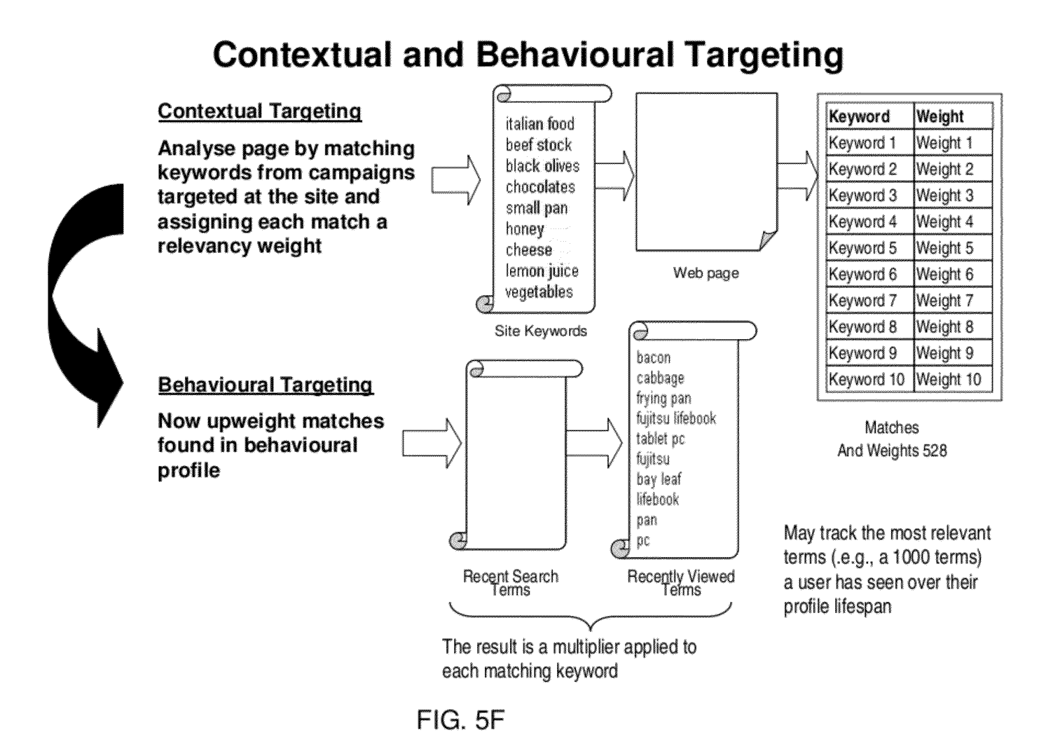

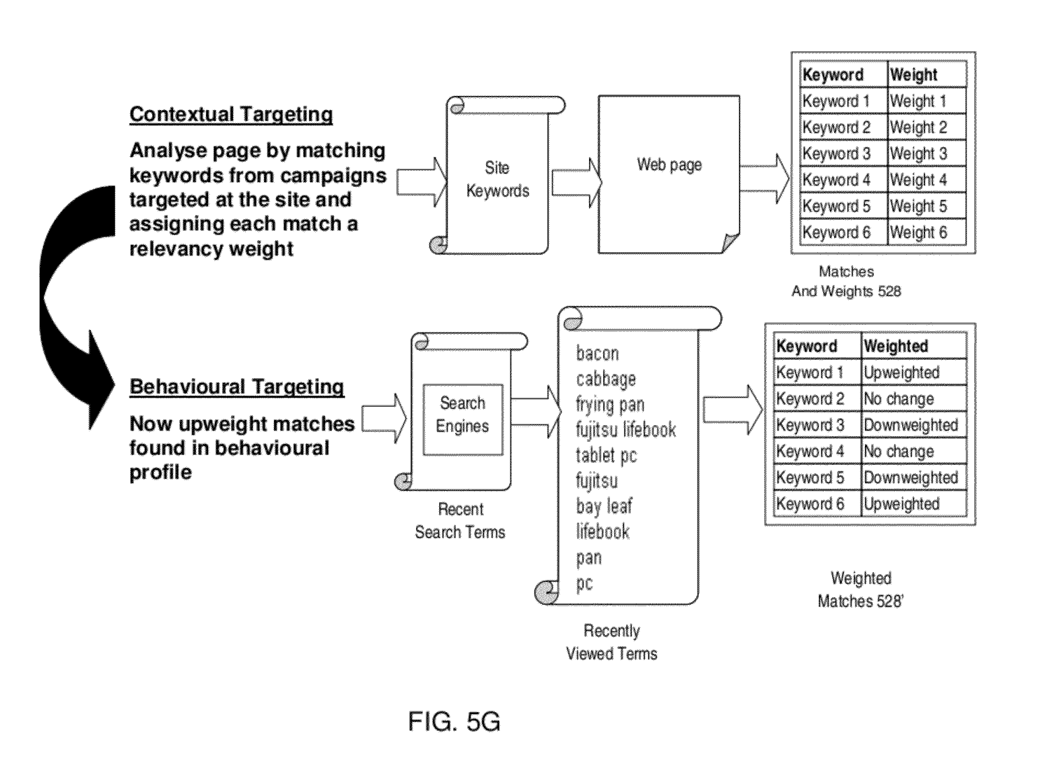

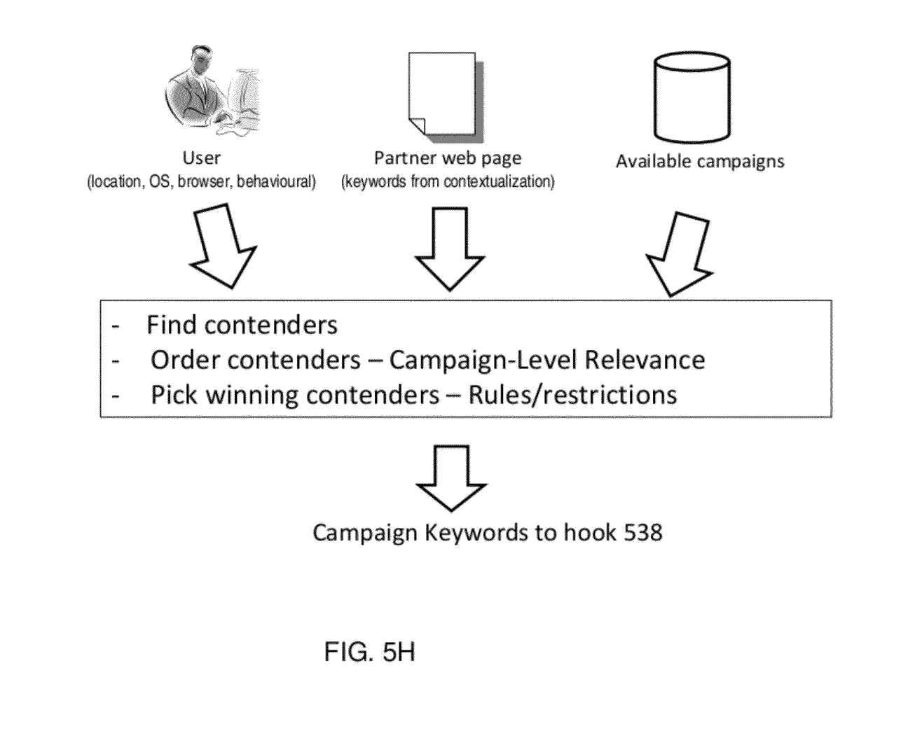

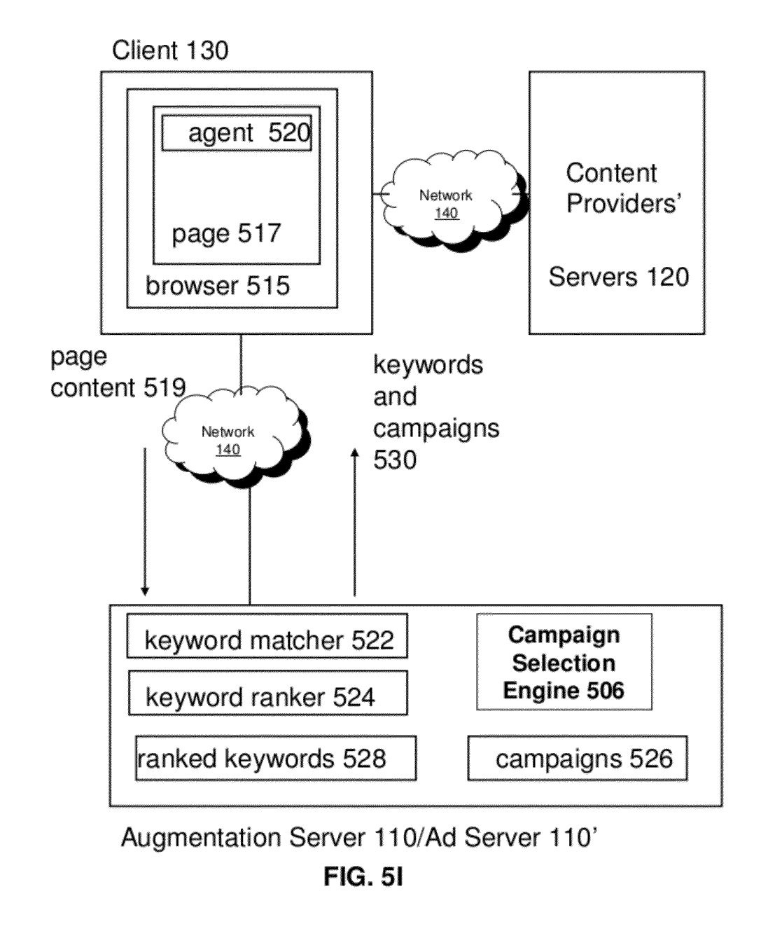

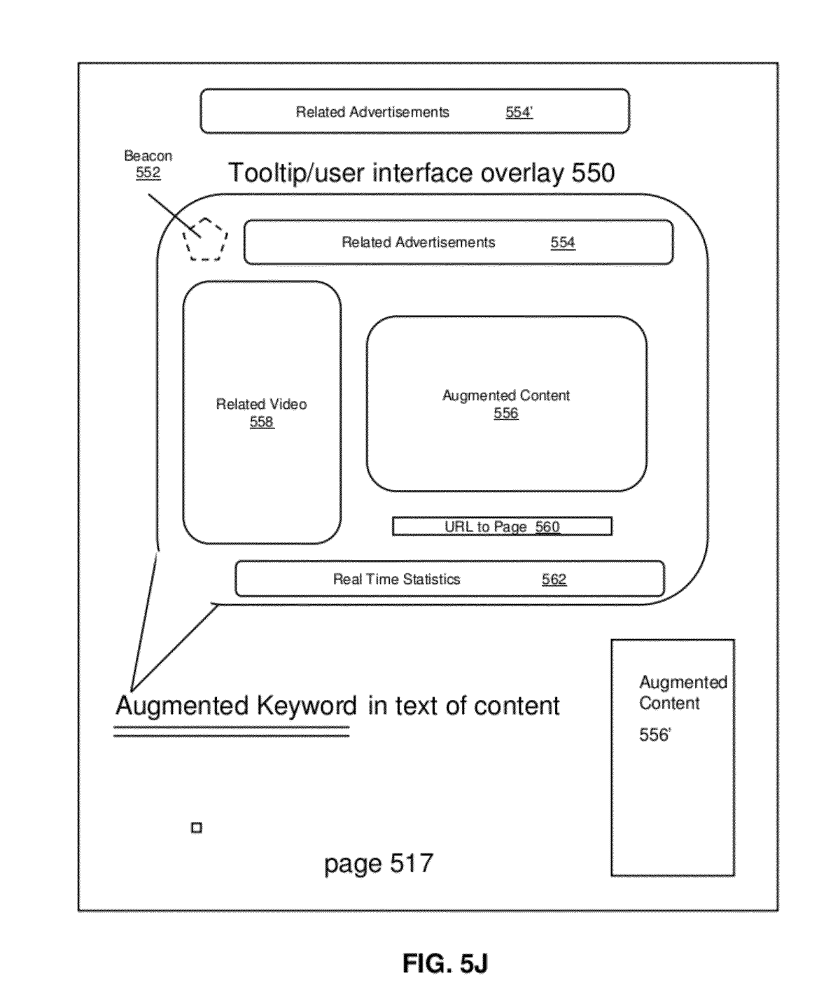

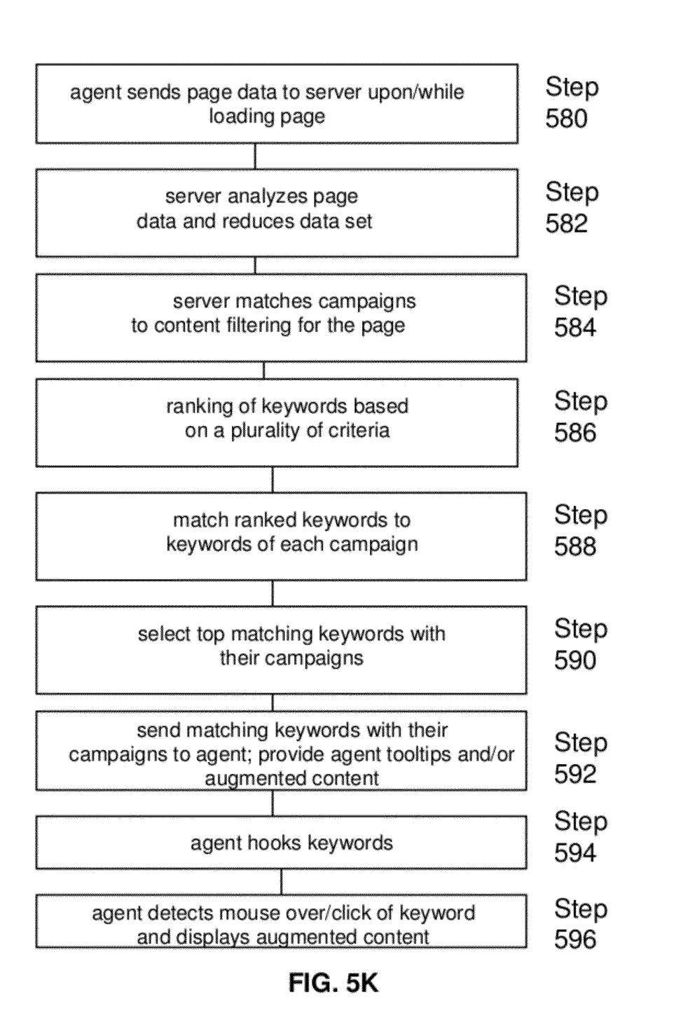

Referring now to FIG. 5A, an embodiment of an environment and systems for providing a plurality of augmented content and related services. In brief overview, an ad server platform 110′ delivers a plurality of services, such an in-text services 510, interest ads 512 and related content 514 services. The ad server platform 110′ may include a context engine 502, an interested engine 504, a campaign selection engine 506 and/or an advert resolution engine. The ad server may include or further include any embodiments of the augmentation server 110 described herein.

The ad server platform 110′ may comprise any combination of modules, applications, programs, libraries, scripts or any other form of executable instructions executing on one or more servers. The ad server platform 110′ may provide services directed to advertisers to reach a plurality of users across a plurality of publisher websites, such as content providers 120. The services of the ad server platform 110′ may combine the precise word targeting with delivery of rich media and video content. The ad server platform 110′ may provide services directed to publishers to received additional advertising revenue and real-estate with adding more clutter on their web-sites. The ad server platform provides a user controlled environment, allowed the user to view augmented content, such as advertising, only when these choose to via mouse interaction over a relevant word of interest—a keyword. As such, an ad impression may be pre-qualified in that a user must choose to view the ad by moving their mouse over or clicking on a word or phrase of interest. This may be referred to as user-initiation impressions.

The ad server platform may provide in-text advertising services 510. In-text services reads web pages and hooks words and word-phrases dynamically and in real time. The hooked words may be linked or hyperlinked to augmented content in any manner. In one embodiments, the words are double underlined but any type of indicator may be used such as a single underline or an icon. In some embodiments, the code for in-text services is installed by publishers into their sites and does not require any additional code, adware or spyware to be downloaded or uploaded by a user. When a user mouses over or clicks on hooked (e.g., double underlined) word or phrase, the code display a user interface overlay, sometimes referred to as a tooltip, on the web page and near the hooked word or phrase.

The ad server platform may provide interest ad services 512. The interest ad services identifies words of interest within a web page to deliver advertisements that are related to these words of interest. The interest ad service may identify the words on the page to analyze those words to determine which words are core or central to that page. These set of core word are keywords to identify one or more ad campaigns relevant to those keywords and the user's interests. This may minimize wasted impressions and deliver and advertising experience that relates more directly to the user's interest.

The ad server platform may provide related content services 514. The related content services may provide, create or generate an automated linking system that conveniently delivers relevant additional content from the same or different publishes in the form of videos, articles and information. The related content services may read web pages and hook words and word-phrases dynamically and in real time. The hooked words may point or navigate the user through content related to the hooked words available through a website, network or portal. For example, the related content service may link a word on the page to re-circulate the user through additional content, such as other web pages, of the publisher. In some embodiments, the related content service may automatically mirror the hyperlink style of a publisher's editorial links or already provided hyperlinks. The related content services may generate or add an icon, such as search icon, that indicates that augmented content is returned or available.

In further details, the ad server platform may comprise one or more context engines 502. The context engine may comprise any type and form of executable instructions executing on a device, such as a server. The context engine may comprise any functions, logic or operations for analyzing content of a web page. The context engine may use any type and form of semantics based algorithm to determine the meaning of the keyword relevant to the content of the page, the user, the web-site, the publisher and/or the campaign. The context engine may determine the intended structure and meaning of words, phrases, sentences or text in the content of the page. The context engine may analyze the text in the content to determine any characters, text, strings, words, terms and/or phrases, or any combinations thereof, that match or correspond to any characters, text, strings, words, terms and/or phrases, or any combinations thereof of any one or more campaigns. The context engine may analyze the content of the page for keywords from campaigns targeted at the web-site, publisher or content provider of the page. The context engine may determine any type of metrics on the content of the web page and of keywords of targeted campaigns of the web page. The context engine may use any type and form of algorithm to determine a keyword relevancy weight such as by location of the keyword, the frequency of the keywords and the length of the keyword. For example, for location weighting, those keywords that appear earlier in the content may be considered more relevant than those that appear later. For frequency relevancy, the more a keyword is repeated within the content, the more relevant the keyword may be considered. For length relevancy, the more words in a keywords the less generic the keyword may be and the more relevant the keyword may be considered.

The ad server platform may comprise one or more interest engines 504. The interest engine may comprise any type and form of executable instructions executing on a device, such as a server. The interest engine may comprise any functions, logic or operations for tracking and storing user information and/or behavior to a behavioral profile. The interest engine may track and store the user's location, operating system and/or browser. The interest engine may track a predetermined number of keywords a user has seen over a certain time period. The interest engine may track a predetermined number of relevant terms a user has viewed over a certain time period. The interest engine may track the a predetermined number of searches for which a user clicked a search result and landed on the content providers web-site or web. The interest engine may store the recent search terms and/or recently viewed terms into a behavioral profile for the user. The ad server platform, context engine and/or interest engine may change the weighting of keywords in content of a page responsive to any information stored in any behavioral profiles. For example, the ad server platform, context engine and/or interest engine may use a multiplier to upweight or downweight one or more keywords.

The ad server platform may comprise one or more campaign selection engines 506. The campaign selection engine may comprise any type and form of executable instructions executing on a device, such as a server. The campaign selection engine may comprise any functions, logic or operations for selecting or matching a campaign to a set of one or more keywords identified and/or weights for content of a page. The campaign selection engine may identify and select a campaign from a plurality of campaigns. The campaign selection engine may identify and select a first set of campaigns from a plurality of campaigns that meet a first threshold or criteria. From the first set of campaigns, the campaign selection engine may order or rank these campaigns using any type and form of algorithms. In some embodiments, the campaign selection engine may provide a campaign-level relevance of the keywords. The campaign selection engine may determine a relevance number or weighting for each campaign relative to the weighted keywords. In some embodiments, each campaign may provide a priority to keywords, web-pages or publishers. In some embodiments, each campaign may provide a relevance weighting to keywords, web-pages or publishers. The campaign selection engine may also comprise any set of one or more rules or restrictions for either changing the ranking, keeping a campaign or removing the campaign. Based on applying these rules and/or restrictions, the campaign selection engine selects from the first set of one or more companies a second set of one or more campaigns to use for augmenting the identified keywords on the web-page.

The ad server platform may comprise one or more advert resolution engines 508. The advert resolution engine may comprise any type and form of executable instructions executing on a device, such as a server. The advert resolution engine may comprise any functions, logic or operations for resolving the advertisement to use for a hook. For each advertisement, the advert resolution engine may determine whether the advertisement is a backfill or to be obtained from a backfill network. If the advertisement is backfill, the advert resolution engine calls or communicates with the backfill provider's servers. For example, the advert resolution engine may include one or more handlers designed and constructed to communicate with a particular backfill provider. When an advertisement is received from the backfill provider or when the advertisement if not coming from a backfill, the advert resolution engine may perform any type and form of filtering on the advertisement, such as for making sure the ad meets any rules or restrictions for content. The advert resolution engine includes a placer for selecting an instance of a keyword to hook with the advertisement. When the advert resolution engine has checked for backfill, filters the advertisement and selected an instance to hook for all the intended advertisements, the advert resolution engine may hook the keywords. The advert resolution engine may perform these operations for content other than advertisements, such as other types of augmented content.

Referring now to FIGS. 5B through 5H, diagrams of embodiments of the functionality and operations of the ad server platform are depicted. FIG. 5b depicts an embodiment of high level overview of the process from the client perspective. FIG. 5C depicts an embodiment of contextual targeting. FIG. 5D depicts an embodiment of keyword relevancy weighting. FIG. 5E depicts an embodiment of behavioral targeting. FIG. 5F depicts a further embodiment of behavioral targeting. FIG. 5G depicts an embodiment of further weighting based on behavioral targeting. FIG. 5H depicts and embodiment of campaign selection.

Referring to FIG. 5A, at step 502, a user on a client 120 requests a page from a publisher, such as a web page of a content provider 120. At step 504, the client receives the page and the browser loads the page. The user may start browsing the web page. At step 506, an agent on the page, such as a script starts an analysis in the background. The agent may be triggered upon loading of the web page or start the analysis upon receipt and/or loading of the web page. The agent may communicate with the ad server platform to perform any of the services of in-text advertising, related content or interest ads. For example, the agent may send content from the page for the ad server platform to analyze. In the background of the user viewing or browsing the web page, the ad server platform may analyze the page, find relevant campaigns filter campaigns and generate a response to the agent for hooking the keywords and identifying or delivering the augmented content. The ad server platform may not analyze pages based on filtering certain URLs. The ad server platform may analyze the content received from the agent, perform any of the services described herein and send the keywords to hook and the corresponding augmented content, such as advertisements from a campaign. At step 508, the analysis is completed and the user sees links to keywords, such as double underlined keywords. As described herein, the user may mouse over or click the hooked keyword and have the augmented content displayed.

Referring now to FIG. 5C, an embodiment of contextual targeting is depicted. This contextual targeted may be performed by the ad server platform and performed in the background while the page is being loaded and browsed/viewed by the user. The ad server platform receives page content from the client, such as via an agent. The ad server platform analyzes the page to match keywords to campaigns targeted to the web-site, page or URL. In some embodiments, the ad server platform finds all campaigns targeted to this site, finds all keywords in those campaigns and forms or generates a site keyword list for this site. The ad server platform may match the keywords from the site keyword list to keywords in the content from the page. The ad server platform may assign each matching keyword a relevancy weight.

Referring now to FIG. 5D, an embodiment of assigning a relevancy weight to each keyword to provide contextual targeting is depicted. The ad server platform may provide a relevancy weight to each keyword of the site keyword list matching content of the web page. The ad server platform may use any type and form of metrics or combinations of metrics to determine a relevancy weight. In some embodiments, the ad server platform uses a location, frequency and/or length metric to assign a relevancy weight to the matching keyword. The location relevancy weight may comprise an indicator or multiplier to those keywords that appear near the beginning or top of the web page relevant to those keywords that appear near the end of bottom of the web page. The frequency relevancy weight may comprise an indicator or multiplier to those keywords that appear more times on the same page or content than other keywords. The length relevancy weight may comprise an indicator or multiplier to those keywords that have more words in the keywords than single keyword or keywords with less words.

Each type of metric relevancy weight may be weighted the same or differently. Each metric relevancy weight may have it owns multiplier or factor that scales the weight for the keyword up or down according to the relevancy. The keyword may be up weighted and/or down weighted one or more times by each of the metric relevancy weights. A keyword relevancy weight may be up weighted by one metric relevancy weight while downloaded by another relevancy weight. For example, a keyword may be repeated several times and be upweighted or have a high multiplier based on the frequency relevancy weight while only found and repeated near the end of the page for a down weighting or low multiplier from the location relevancy weight. In some embodiments, a keyword may get a low relevancy weighting from each of the metric relevancy weightings. In some embodiments, a keyword may get a high relevancy weighting from each of the metric relevancy weightings. In some embodiments, a keyword may get a combination of low and high relevancy weightings from different relevancy weightings.

Referring now to FIG. 5E, an embodiment of applying behavioral targeting is depicted. The ad server platform may identify, track and store formation about a user's behavior in a behavioral profile. The behavioral profile may comprise a profile for one user or a plurality of users. Each of the user's profile data may be identified, tracked and managed via unique user identifiers. In some embodiments, the ad server platform may track a predetermined number of search terms, such as 5, that the user last searched. In some embodiments, the ad server platform may track a predetermined number of search terms for each search engine, such as the Google search engine, Microsoft Bing search engine, Yahoo search or Ask search engine. In some embodiments, the ad server platform may track a predetermined number of search terms for each search engine across a combination of search engines. In some embodiments, the ad server platform tracks and stores those search terms for which the user clicked a search result. In some embodiments, the ad server platform tracks and stores those search terms for which the user clicked a search result. In some embodiments, the ad server platform tracks and stores those search terms for which the user clicked a search result and landed on a web page of a predetermined content provider or publisher.

Referring to FIG. 5F, a further embodiment of behavioral targeting is depicted. The ad server platform may track and store in the behavioral profile of a user a history of terms the user has seen over a predetermined time period. In some embodiments, the ad server platform tracks terms has a user has viewed on a web page. In some embodiments, the ad server platform tracks terms the user has selected from a search or interacted with during the user's viewing history. In some embodiments, the ad server platform tracks terms of one or more search results from which the user has clicked through. In some embodiments, the ad server platform tracks viewed terms over a predetermined time period. In some embodiments, the ad server platform tracks viewed terms over a start of a behavioral profile of the user to current time.

The ad server platform may use any of the search terms and/or viewed terms from the behavioral profile to make a change to the relevancy weightings of the matching keywords. Those matching keywords that the use has searched or viewed previously will have their relevancy weightings increased or upweighted via a behavioral targeting multiplier. In some embodiments, the ad server platform may use a combination of recently searched and viewed terms to apply a multiplier to each matching keyword. The ad server platform may use any temporal threshold to determine which search terms and/or viewed terms to use for determining a multiplier to the relevancy weightings of the matching keywords. The ad platform may apply higher behavioral targeting multipliers to those keywords that were recently viewed and/or recently search within a predetermined time history. The ad platform may apply no or lower behavioral targeting multipliers to those keywords that were not recently viewed and/or not recently search within the predetermined time history.

As a result of using behavioral profile data and behavioral targeting multipliers, as depicted in FIG. 5G, the ad server platform modifies the relevancy of the matching keywords from the site keyword list. The matching keywords are assigned a first relevancy weighting from the contextual targeting and are modified or changed to a second relevancy weighting from the behavioral targeting. In some embodiments, the ad server platform maintains both the contextual targeting relevancy weightings and the behavioral targeting relevancy weighting for each matching keyword. In some embodiments, the ad server platform maintains a single relevancy weighting keyword comprising the behavioral targeting multipliers (up weighting or down weighting) to the relevancy weighting applied by the contextual targeting.

Referring to FIG. 5H, an embodiment of campaign selection is depicted. In some embodiments, the results of contextual and/or behavioral targeting are used as input to the campaign selection engine. The ad server platform may use the relevancy weightings of the matching keywords from the site keyword list to determine which campaigns may be applicable to these matching keywords. Those campaigns not having keywords corresponding to any of the matching keywords may be dropped from consideration. In some embodiments, those campaigns not having a number of keywords corresponding to the matching keywords within a predetermined threshold may be dropped from consideration. In some embodiments, those campaigns having one or more keywords corresponding to a predetermined number of the top relevancy weighted keywords may be identified for consideration.

The ad server platform may order the list of campaigns under consideration using any type and form of algorithm. For example, the ad server platform may rank the campaigns based on having matching keywords with the highest combined relevancy weightings. The ad server platform may rank the campaigns based on having the highest number of matching keywords. The ad server platform may rank the campaigns based on a combination of the highest combined relevancy weightings and the highest number of matching keywords. The ad server platform may also order campaigns based on any type of priorities assigned to the campaigns. Some campaigns may have a high order of priority to deliver or serve than other campaigns.

The ad server platform may selected the campaigns to deliver from the ordered or ranked list of campaigns. The ad server platform may further restrict the selection based on any rules or policies of the ad server platform, the publisher or the campaign. For example, the campaign or publisher may have rules restricting the serving of a campaign directed to certain users, times of days, locations, browsers, or content. Once the selection of the one or more campaigns is made, the ad server platform generates a list of campaign keywords to hook and transmits these keywords to the agent of the client. The ad server platform may provide to the agent information on the publisher, campaign, tooltip/user interface overlay and/or augmented content with or corresponding to the keyword.

Referring now to FIGS. 5I, 5J and 5K, embodiments of systems and methods for delivering augmented content are depicted. FIG. 5I depicts an embodiment of a system for analyzing content of a page to determine keywords to augment for one or more campaigns. FIG. 5J depicts an embodiment of augmented content delivered to a web page of a client. FIG. 5k depicts embodiments of a method for analyzing and hooking keywords on a web page of a client.

In brief overview of FIG. 5I, an embodiment of a system for augmented keywords on a web page is depicted. A client 130 communicates with one or more content providers 120, such as publishers, via network(s) 140. The client 120 may include a browser that receives loads and displays content in the form of web page or pages 517 from the one or more contents providers. The client 130 also communicates with the augmentation server or ad server 110′. The page 517 being loaded or loaded by the browser comprises an agent 520. The agent 520 may communication page content 519 to the server 110, 110′ for analysis and received from the server 110, 110′ keywords, corresponding campaigns and/or augmented content. The keyword matcher 522 of server 110, 110′ may perform keyword matching, such as using site keyword list, on the page content 519 received from the agent 520. The keyword ranker 524 ranks the keywords to provide ranked keywords 528. The campaign selection engine 506 selects campaigns 526 based on the ranked keywords 528.

In further detail, the browser 515 may comprise any type and form of executable instructions for accessing information resources via a network 140 such as the Internet. The browser may include any user agent or software for retrieving, presenting, accessing and/or traversing information resources or documents on the world wide web or a network 140. The browser may include any functionality for loading, running, processing and/or displaying on a computer screen information written in HTML, XML, javascript, java, flash or any other language or a script used for web pages. Browser may include any functionality for displaying any type and form of content or features presented by web page or transmitted content provider 120. Browser may include any functionality for enabling a user to interact or interface with a web page. Browser may provide functionality for displaying advertisement information within a web page presented or displayed on a computer screen of client computer 130. In some embodiments, a browser is any version of Internet Explorer web browser manufactured by Microsoft Corp. In other embodiments, the browser is any version of the Chrome web browser manufactured by Google Inc. In other embodiments, the browser is any version of Firefox web browser distributed by the Mozilla Foundation. In further embodiments, the browser is any version of the Opera browser by Opera Software ASA.

The page 517 may include any type and form of content processable by any embodiment of the browser 515. The page may be stored on any number of servers, such as content providers 120 and may be accessed and/or loaded by any web browser, such as browser 515. The page may be a web page. The page be a document, The page may be a file. The page may any resource accessible via a network or a world wide web by a networked device, such as a client computer 130. The page may be identified by a URL. The page may include content from a URL. The page may include any type and form of executable instructions, such as scripts, AJAX. The page may include any type and form of graphics and/or text. The page may include any type and form of media, such as video or audio media. The page may include content having text, words, keywords and links or hyperlinks to other web pages or web sites.

Page 517 may include any document which may be accessed, loaded, viewed and/or edited by a browser 620 and displayed on a computer screen. Page 517 may include any content which may be presented via hypertext markup language, extensible markup language, java, javascript or any other language or script for preparing web pages. Web page may include any type and form of components for adding animation or interactivity to a web page, such as Adobe Flash by Adobe Systems Inc. The page may include functionality for displaying advertisements, such as advertisements from enterprises, government, companies and firms. A web page may include any number of ad spaces providing space or arrangement within web page for displaying advertisement.

The client, browser or page may include an agent 520. The agent may include any type and form of executable instructions executable by the browser and/or client. In some embodiments, the agent comprises a script, such as JavaScript or JSON (JavaScript Notation). In some embodiments, the agent may comprise any type and form of plug-in, add-on or component to or of browser 515. In some embodiments, the agent may comprise any type of application, program, service, process or task executable by the client.

The agent 520 may be included in the page 517 when transmitted by the content provider. In some embodiments, the page includes the agent in script form as part of the content of the page. In some embodiments, the page includes a URL to the script, such as URL pointing to or identifying a resource or script of the servers 110, 110′. In some embodiments, the agent is loaded by the browser. In some embodiments, the agent is executed by the browser upon retrieval and/or loading of the page 517. In some embodiments, the page includes instructions to the browser or client to obtain and load or install the agent.

The agent 520 may include any logic, function or operations to interface to or communicate with any portion of the augmentation server 110 or ad server platform 110. The agent may include any logic, function or operations to provide any of the services or functionality of in-text 510, interest ads 512 and/or related content 514. The agent may include any logic, function or operations to identify, collect and transmit content from the page to the server 110/110′. The agent may identify, collect and transmit any and/or all text in content of the page. The agent may identify, collect and transmit any and/or all text from any pages or URLs referred to by the page. The agent may transmit any embodiments of this page content 519 to the server 110, 110′.

The agent may comprise any logic, function or operations to receive keywords, campaigns and/or augmented content from the server 110, 110′. The agent may comprise any logic, function or operations to hook keywords identified in the page content. The agent may “hook” keywords by modifying the keyword in the page content to have an indicator, such as double underlined or an icon. Hooking a keyword refers to making a keyword on the page have a predetermined visual appearance to indicate that interactivity would or may occur by the user interacting with the keyword and instrumenting the page or keyword to perform the interactivity responsive to the user interaction. The indicator may provide a visual indication that the keyword in the text is linked or hyperlinked. In some embodiment, the agent may link or hyperlink the keyword. The agent may hook the keyword to include a function, script or executable instruction to take an action responsive to a mouse over, mouse click or other user interaction. The agent may hook the keyword to display a user interface overlay or tooltip such as depicted in FIG. 5J. The agent may hook the keyword to display a related advertisement or augmented content on the page as also depicted in FIG. 5J.

The keyword matcher 522 of the server 110, 110′ may comprise any type and form of executable instructions executable on a device. The keyword matcher may comprise any logic, function or operations to identify matches between one data set and another data set. In some embodiments, the keyword matcher may identify matches between keywords of campaigns with page content. In some embodiments, the keyword matcher may identify whole or complete matches. In some embodiments, the keyword matcher may identify partial or incomplete matches. In some embodiments, the keyword matcher may identify partial or incomplete matches within a predetermined threshold. In some embodiments, the keyword matcher may identify both complete and incomplete matches. The keyword matcher may perform any of the keyword operations described in connection with FIGS. 5A through 5F. The keyword matcher may be included as part of the context engine, interest engine or campaign selection engine of the ad server platform.

The keyword ranker 522 of the server 110, 110′ may comprise any type and form of executable instructions executable on a device. The keyword ranker may comprise any logic, function or operations to rank a set of data responsive to one or more criteria. The keyword ranker may comprise any logic, function or operations to rank keywords matched to page content. The keyword ranker may comprise any logic, function or operations to provide a weighting to a keyword based on any metrics of the keyword, such as location, frequency, and length. The keyword ranker may comprise any logic, function or operations to provide a weighting to a keyword based on relevancy to the site. The keyword ranker may comprise any logic, function or operations to provide a weighting to a keyword based on relevancy to a publisher or content provider. The keyword ranker may comprise any logic, function or operations to provide a weighting to a keyword based on relevancy to a campaign. The keyword ranker may comprise any logic, function or operations to provide a weighting to a keyword based on relevancy to a user or behavioral profile. The keyword ranker may be included as part of the context engine, interest engine or campaign selection engine of the ad server platform.

The keyword ranker may perform any of the keyword ranking and/or weighting operations described in connection with FIGS. 5A through 5F. An output or result of the keyword ranker may be ranked keywords 528. The ranked keywords may include any type of object, data structure or data stored in memory or to storage. The ranked keywords may include contextually targeted ranked keywords as described in connection with FIGS. 5A through 5F. The ranked keywords may include behavioral targeting ranked keywords as described in connection with FIGS. 5A through 5F. The ranked keywords may include any combination of contextually targeted ranked keywords and behavioral targeting ranked keywords. The ranked keywords may be site specific. The ranked keywords may be campaign specific. The ranked keywords may be publisher specific. The ranked keywords may be based on any combination of site, campaign and/or publisher.

The campaign selection engine 506 may interface or communicate with any of the keyword matcher, the keyword ranker and/or ranked keywords. The campaign selection engine 506 may access, read or process campaigns 526. The campaigns 526 may be stored in any type and form of database or file system. The campaigns 526 may include information identifying keywords for the campaigns and augmented content to deliver for those keywords. The campaigns 526 may include any type and form of content, URLS, scripts, video, audio, advertisements, media, text, graphics, data, information etc. to provide as augmented content with the keywords. The campaigns 526 may include any type and form of URLs, advertisements, media, text, graphics, etc. to provide as augmented content with the keywords. The campaigns may identify or provide any desired user interface overlay/tooltip or content therein. The campaigns may be organized by publisher. Each publisher may have a plurality of campaigns.

The campaign selection engine selects the campaign to deliver with the page based on analysis of the page content from the keyword matcher, keyword ranker and ranked keywords. The campaign selection engine may comprise any type and form of logic, functions or operations to identify and select one or more campaigns from a list of contender or candidate campaigns based on any criteria or algorithm. The campaign selection engine may select those campaigns that best match or correspond to the top ranked keywords. The campaign selection engine may select those campaigns that match or correspond to a predetermined number of ranked keywords. The campaign selection engine may select those campaigns that match or correspond to a predetermined set of ranked keywords. The campaign selection engine may select those campaigns that match or correspond to the ranked keywords in accordance with a priority assigned to the campaigns or publisher. The campaign selection engine may exclude or include campaigns based on the logic or criteria of any rules or filters.

Responsive to the campaign selection engine, the server 110, 110′ may transmit to the agent identification of one or more keywords to augment on the page and corresponding campaigns for those keywords (see 530). The server may transmit to the agent any script, data or information to provide or facilitate hooking of the keywords on the page and displaying the campaign responsive to user interaction with the keyword. The server may transmit to the agent the indicator, or identification of the indicator) to use for a hooked keyword. The server may transmit to the agent the type and form of user interface overlay to display when a user mouse over or mouse click occurs for the keyword. The server may transmit to the agent a reference to or identification of any of augmented content to display when a mouse over or mouse click occurs for the keyword. The server may transmit to the agent the augmented content, such as the advertisement, to display when a mouse over or mouse click occurs for the keyword.

The agent may receive the information 530 from the server and modify the page or content of the agent to perform the hooking of the keywords, to instrument the hooked keywords, and/or deliver the campaign responsive to the keyword. The agent may perform any of the agent's logic, functions or operations while the web page is being loaded. The agent may perform any of the agent's logic, functions or operations while the user views or browsers the web page. The agent may perform any of the agent's logic, functions or operations in the background to the user viewing or browsing the page.

Referring now to FIG. 5J, embodiments of augmented content delivered with a corresponding keyword is depicted. In brief overview, the page 517 may include an augmented keyword in the text of the content (e.g., see double underlined “Augmented Keyword” next to “in text of content”). When a user interacts with the augmented keywords, a user interface overlay 550, also referred to as tooltip, may be displayed. This user interface overlay may deliver or provide the campaign corresponding to the keyword. Responsive to user interaction with the keyword, the agent may display related advertisements 554′, such as via a banner ad, or augmented content 556′. The related advertisements 554′ and/or augmented content 556′ may be displayed in connection with the tooltip, without the tooltip or instead of the toolip.

Any of the content on page 517 may include any embodiments of the advertisements and/or augmented contented provided and discussed above in connections with FIGS. 1 through 4E. The tooltip may be part of a multi-layered augmentation content or advertisement unit. The tooltip may provide any one or more URLs to access related websites.

The user interface overlay 550 referred to as a tooltip may include any type and form of web beacon 545. In some embodiments, the tooltip 550 may include a plurality of web beacons. The beacon may be used for tracking a user's usage and/or interactions with the tooltip. The beacon may identify or track a length of time of any user interaction with the tooltip and/or augments keyword or inline text. The beacon may identify a URL or tracking system to register or send communications regarding the user interaction. In some embodiments, a web beacon may be designed and constructed for a predetermined tracking system.

A web beacon may be an object that is embedded in the tooltip that is not visible to the user. Sometimes beacons are referred to as web beacons, web bugs, tracking bugs, pixel tags or clear gifs. Web beacons may be used to understand the behavior of users who frequent designated web pages. A web beacon permits a third party to track and/or collect various types of information. For instance, a web beacon may be used to determine who is reading a webpage, when the webpage is read, how long the page was viewed, the type of browser used to view the webpage, information from previously set cookies, and from what computer the webpage is accessed.

The tooltip may be incorporated, integrated or presented with any one or more of related advertisements 554, related video 558 and/or real time statistics 562. The tooltip 550 may include an URL 560 to any web page or resource, such as additional content, search results, or media. Although the tooltip 550 is illustrated each with a related advertisement, related video and related statistics, the tooltip 550 may be presented with one of these related content or a plurality of these related contents. Although this related content is illustrated in a location, size and position in relation to the tooltip, the related advertisements, related video, and/or real time statistics may be arranged, organized or presented in any manner.

The tooltip may also include one or URLs 560, such as a hypertexted URL or link to any other page or content. In some embodiments, the hypertexted link 560 comprises a URL of a landing page of a web site. In some embodiments, the hypertexted link 560 comprises a URL of a web page providing search results directly from the search engine. In another embodiment, the hypertexted link 560 provides a link to a recommend or most relevant search result. In other embodiments, the hypertexted link 560 provides a link to run the search query on a second search engine. The hypertexted link 560 may bring the user to a landing page of the search results of the second search engine.

The related advertisements 554 may include any type and form of advertisement related to the augmented content or inline text or otherwise related to the keyword. In some embodiments, the related advertisements are advertisements provided as described in connection with any of the embodiments of the FIGS. 1A-4E. In some embodiments, the related advertisements are advertisements provided by a search engine, such as in relation to and based on the search query. In other embodiments, the related advertisements are provided by any type and form of ad network via the server 110, 110′ and/or search engine.

The related video 558 may include any type and form of video media related to the augmented content or inline text or otherwise related to the keyword. In some embodiments, the related videos are advertisements provided as augmented content as described in connection with any of the embodiments of the FIGS. 1A-4E. In some embodiments, the related videos are videos provided by a search engine, such as in relation to and based on a search query. In other embodiments, the related videos are provided by any type and form of video service, such as YouTube.com or iTunes.com. In another embodiment, the related videos are videos available to the user via a user accessible storage or video management system.

The real time statistics 562 may include any type and form of statistics related to the augmented content or inline text or otherwise related to the keyword. In some embodiments, the real time statistics 562 may be any statistics related to the person or entity of the search. For example, if the augmented keyword is a sports team, the real time statistics may include current or recent game scores and/or standings of the team. In another example, if the augmented keyword is related to the weather, the real time statistics may include a current weather forecast. In one example, if the augmented keyword is related to a musician, the real time statistics may include statistics on music downloads, album sales and top music chart location.

Referring now to FIG. 5K, embodiments of a method for augmented content of a keyword of a web page being loaded into a browser is depicted. In brief overview, at step 580, an agent of the browser to server 110, 110′ upon or while loading a web page. At step 582, the server analyzes the page data and reduced the page data set. At step 584, the server performs content filtering on page and keywords to match to corresponding campaigns. At step 586, the server performs ranking of keywords. At step 588, the server matches the ranked keywords to keywords of each campaign. At step 590, the server selects top matching keywords and their campaigns. At step 592, the server sends to the agent the selected keywords and their campaigns and may provide the agent tooltips and/or augmented content. At step 594, the agent hooks the keywords identified by the server. At step 596, the agent detects user interaction such as mouse over or click of keywords and displays augmented content, such as a tooltip.

In further details, at step 580, the agent may be executed by the browser upon or while loading the web page. The browser may retrieve the agent via a URL identified by the page. In some embodiments, the page transmitted by the server includes the agent. The agent may comprise script places or arranged at or near the top page to be executed by the browser. In some embodiments, the agent may be triggered by any load events or APIs of the browser. The agent may be executed prior to content of the web page being loaded or displayed. The agent may be executed prior to the retrieval of any URLS of the page. The agent may be executed prior to completion of loading of the web page by the browser.

The agent may identify, gather and aggregate data from the page. The agent many identify all text portions of the web page. The agent many identify those elements of the page that contain text. The agent may identify text from a predetermined set of elements of the page. The agent may identify text from HTML, XML or other page languages. The agent may identify text from the body of an HTTP portion of the page. The agent may perform text recognition on any portion of the page or any element of the page. The agent may identify text from any URLS or other content referred to or loaded by the page. The agent may identify any other date of the page, including headers. For example, the agent may identify the browser type, the user, location, IP addresses from the content of the page or from any of the network packets used for communicating the page. In some embodiments, the agents performs analysis and identified metrics for the page date, such as text location, frequency, length and repeatability.

The agent may gather the identified page data, text or otherwise, and/or any page metrics and transmits the page data and/or page metrics to the server 110, 110′. In some embodiments, the agent transmits the page data together in one transaction with the server. In some embodiments, the agent transmits portions of page data in a series of transactions with the server. In some embodiments, the agent transmits the page data using any type and form of protocol. In some embodiments, the agent transmits the page data as a background process to the browser loading the page or the user browsing the page. In some embodiments, the agent transmits the page data while the browser is loading the page.

At step 582, the server analyzes the page data and reduces the page data to a working set of page data to continue analysis. The server may remove a predetermined set of commons words, such as a, and, the, from the page data. In some embodiments, the server may filer a predetermined set of words, phrases, terms or characters according to any filters, rules or policies. In some embodiments, the server may identify and correct any typos or other inadvertences with the page data. In some embodiments, the server may perform any type and form of metrics on the page data. In some embodiments, the server may identify location, frequency, repeatability of text on the page. In some embodiments, the server may identify location, frequency, repeatability of text on the page data relative to other text on the page.

At step 584, the server analyzes the text from the working set of page data to determine if there is any type and form of matching to any campaigns. In some embodiments, the server performs any type and form of semantic matching to match keywords on the page semantically to concepts, meanings, categories, subject matter and/or keywords of campaigns. In some embodiments, the server performs a phonetic match between keywords on the page to keywords of campaigns. In some embodiments, the server performs a spelling match between keywords on the page to keywords of campaigns. In some embodiments, the server performs content filtering on text, words, and portions of content around the keywords on the page to determine a context for the keywords and match that context to campaigns. In some embodiments, the server performs content filtering on the page data to determine a category, a sub-category, a topic, subject matter or other information indicator and matches the same to any one or more campaigns.

In some embodiments, the server may generate a set of keyword from campaigns targeted towards the site of the page or publisher of the page. The server may generate a site keyword list. The keyword matcher of the server may match keywords from a keyword list, such as the site keyword list, against text of the page data to identify keywords in the page data. In some embodiments, the keyword matcher identifies multiple word phrase matches. In some embodiments, the keyword matcher identifies partial word phrases. In some embodiments, the keyword matcher identifies a number of times or the frequency for which a keyword is found in the page data. In some embodiments, the keyword matcher identifies the location of the keyword in the page data, and in further embodiments, relative to other keywords or boundaries of the page, such as top or bottom.

At step 586, the server performs any type and form ranking of keywords of the page data identified by the keyword matcher. The keyword ranker may rank all of the matching keywords. The keyword rank may rank a predetermined number of keywords. The keyword ranker may rank the keywords according to any one or more metrics. The keyword ranker may rank the keywords according to any one or more criteria. The keyword ranker may rank each keywords by applying a weight to a value assigned to the keyword. The keyword ranker may provide any multipliers to a valued or weighted value of the keyword to increase or decrease the ranking of the keyword. The keyword ranker may rank the keywords on any type and form of scale, which may be absolute or relative.

At step 588, the server matches the ranked keywords to keywords of one or more campaigns. The keyword matcher, ranker or campaign selection engine may compare the list of ranked keywords, or any portions thereof, to a list of keywords of one or more campaigns. In some embodiments, the server identifies those campaigns that are contenders to be a selected for the campaign for this page. In some embodiments, the server identifies those campaigns associated with or assigned to be a campaign targeted to site or publisher of the page. The server may match the ranked keywords against the identified campaigns. In some embodiments, the server may match the ranked keywords against all campaigns. In some embodiments, the server may change the ranking of the keywords based on results of matching the keywords from the campaigns.

At step 590, the campaign selection engine selects a predetermined number of matching keywords and their campaigns. In some embodiments, the campaign selection engine selects a predetermined number of top matching keywords and their campaigns. In some embodiments, the campaign selection engine selects a number of top matching keywords and their campaigns corresponding to a number of matching keywords on the page. For example, if there are five unique keywords on the page and each identified by a campaign, the server may select five campaigns. In some embodiments, the campaign selection engine may select one campaign for a plurality of corresponding matching keywords on the page.

In some embodiments, the campaign selection engine may filter out campaigns based on any type and form of filter rules. The campaign selection engine may rank campaigns according to any type and form of ranking. For example, the campaign selection engine may prioritize campaigns according to clients, volume, importance, spend, budget, historical campaign performance or any other desired criteria. The campaign selection engine may compare the ranked keywords to the ranked campaigns. The campaign selection engine may select any of the higher or highest ranked campaigns matching any of the higher or highest ranked keywords.

At step 592, the server sends to the agent the selected keywords and their campaigns. Responsive to the campaign selection engine, the server may send to the agent the list of keywords to augment or hook and their corresponding campaigns. In some embodiments, the server sends a predetermined number of additional keywords to augment or hook in case the agent cannot hook or augment any one or more keywords in the list of keywords. In some embodiments, the server sends an ordered list of keywords. The ordered list of keywords may identify a priority of augmentation or hooking to the agent.

The server may send any type and form of information to the agent on how to augment or hook a keyword, what type of augmentation to use and identifying the form and content of the augmentation. In some embodiments, the server sends to the agent publisher and campaign identifiers for the agent to obtain or identify the appropriate campaign for a keyword. In some embodiments, the server sends the agent an indication of the visual indicator to use for the hooked keyword (e.g., double underlined). In some embodiments, the server sends the agent the executable instructions by which the keyword is hooked or for replacing the text of the keyword with a hooked keyword.

In some embodiments, the server sends instructions for content, construction and/or display of the tooltip. In some embodiments, the server sends a set of executable instructions providing the tooltip and/or any portion thereof. In some embodiments, the server sends a set of executable instructions providing the augmented content and/or any portion thereof. In some embodiments, the server sends a set of executable instructions providing any embodiments of the augmented content, advertisements and/or tooltip of FIG. 5I. In some embodiments, the server sends content for the tooltip to provide the campaign assigned to the keyword. In some embodiments, the server sends one or more URLs referencing a campaign to be delivered via a web-site. For example, in some embodiments, the server sends one or more URLS to advertisements to be delivered for the campaign. In some embodiments, the server sends one or more scripts to agent to provide any of the above embodiments.

At step 594, the agent hooks the identified keywords on the page The agent may replace each keyword in the identified list of keywords from the server with instructions or code to hook the keyword. The agent may have hyperlink or link the keyword to a set of code or executable instructions to display the tooltip, augmented content or any embodiments of FIG. 5J. The agent may use modify the keyword to provide any type and form of visual indicator (e.g., double underlined or icon) to indicate the keyword is user interactive, hyperlinked or linked or otherwise hooked. The agent may modify the page to change the text to a liked or hooked text and to link or associated any forms of augmented content of FIG. 5J to be displayed or provided via user interaction with the hooked text. The agent may modify the page or instrument the keyword to detect when a user interacts with the keyword in a certain way. The agent may include one or more event based functions that are trigged responsive to predetermined user interactions. For example, the agent may modify the page or instrument the keyword to detect when a user mouses over the keyword, clicks on the keyword, right clicks on the keyword or left clicks on the keyword or otherwise selects any predetermined set of keystrokes or sequence of keystrokes.

At step 596, the agent detects user interaction such as mouse over or click of a keyword on the page and displays augmented content, such as a tooltip. The agent may detect when a mouse is over the keyword at any time. The agent may detect when a user has the cursor over the keyword. The agent may detect when a user has put focus on the keyword. The agent may detect when a mouse is over the keyword for a predetermined period of time. The agent may detect when a user highlights or selects a keyword. The agent may detect when the user left or right clicks on the keyword. The agent may detect when a user double clicks the keyword. The agent may detect when a user has put focus on the keyword and hit entered. The agent may detect any set of keystrokes with respect to the keyword.

Responsive to the detection, the agent may display augmented content, for example, any of the forms depicted in FIG. 5I. In some embodiments, responsive to detecting a mouse over of the keyword, the agent displays a tooltip delivering a campaign assigned to the keyword. In some embodiments, responsive to detecting a click on the keyword, the agent displays a tooltip delivering a campaign assigned to the keyword. Responsive to detection of the predetermined user interaction, the agent may display augmented content of any form, such as related videos, in predetermined areas or space on the page. Responsive to detection of the predetermined user interaction, the agent may display advertisements of any form, in predetermined areas or space on the page.

In some embodiments, the tooltip may remain displayed until the mouse is moved off of the keyword. In some embodiments, the tooltip may remain displayed until the mouse is moved off of the keyword for a predetermined time. In some embodiments, the tooltip may remain displayed until the mouse is moved off of the keyword until the user closes or exists the tooltip. In some embodiments, if the user clicks on the keyword after the mouse over, the tooltip remains displayed until the user closers or exits the tooltip. In some embodiments, any augmented content may change as the user moves the focus or mouse over to another keyword. For example, moving the mouse to a second keyword may cause a different advertisement to appear in a banner ad or may cause a new tooltip to be displayed or content of the current displayed tooltip to change.

The agent and may perform all or any of the steps of the method of FIG. 5K in real-time upon receipt and/or loading of the page. For example, the agent and the server may be designed and constructed to perform embodiments of steps 580 through 594 within a predetermined time while the page is being loaded by the browser. In some embodiments, the agent and the server may perform embodiments of steps 580 through 594 in milliseconds, for example within in 100, 200, 300, 400, 500, 600, 700, 800 or 900 milliseconds or within 10, 20, 30, 40, 50, 60, 70, 80 or 90 milliseconds, or within 1, 2, 3, 4, 5, 6, 7, 8 or 9 milliseconds or 0.1, 0.2, 0.3, 0.4, 0.5, 0.6, 0.7, 0.8 or 0.9 milliseconds. The agent and the server may be designed and constructed to perform embodiments of steps 580 through 594 while the page is loading and before the page is completely loaded. The agent and the server may be designed and constructed to perform embodiments of steps 580 through 594 in the background while the pages is being loaded and/or the user is browsing the loaded page.

### D. Systems and Methods of Using Behavioral Targeting to Augment Webpage Content

Systems and methods of embodiments of the present solution provide an individualized approach to delivering augmented content responsive to the behavior of a user. The system creates and maintains a profile for a user which tracks the user's interaction and behavior with the content of a web page. By storing and analyzing the profile, the system is able to provide more relevant content to the user based upon the user's behavior and history. Continuous updates to the user profile permit the system to provide up-to-date and relevant content responsive to the user's evolving or changing behavior.

The behavioral targeting system provides a way of tracking a user across various sites of content providers. The data tracked include the key words or terms which are displayed on each page a user visits. Key words or terms repeatedly appear on pages viewed by the user indicate an interest level in the given subject matter. The system provides the ability to rank or weight the identified key words or terms to provide personalized content relevant to the interests of the user.

The present disclosure provides relevant content based on the behavior and history of a user. A unique identifier is assigned to each user and the user's interactions with a web page are recorded and associated with the unique identifier. Based on the historic information collected from the user, personalized, customized or targeted content is presented to the user the next time the user visit the web page. The system presents relevant and personalized content responsive to the evolving or changing behavior of the user.

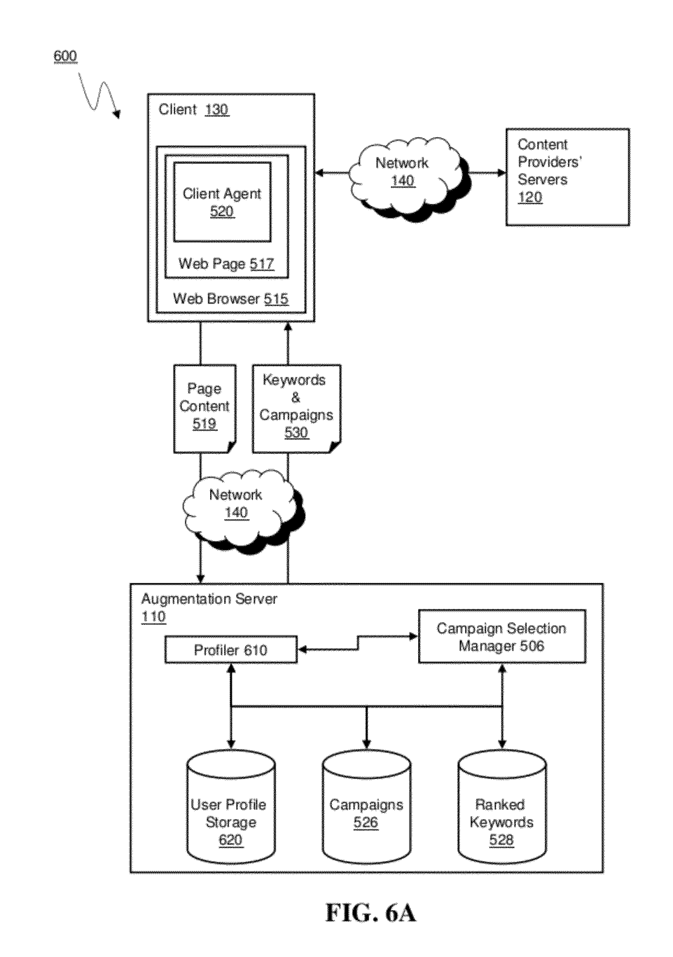

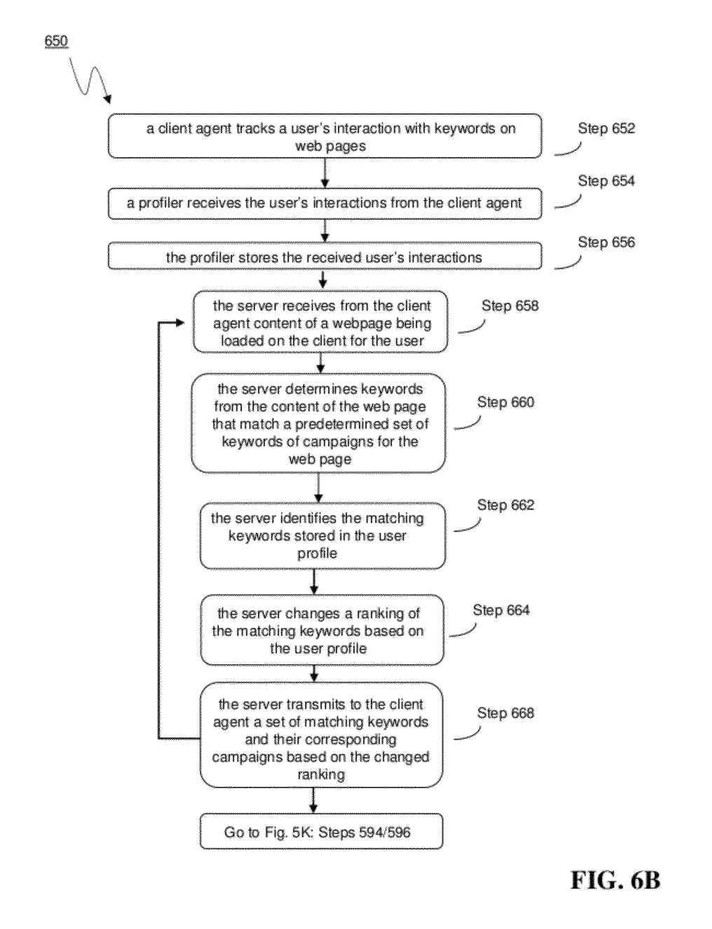

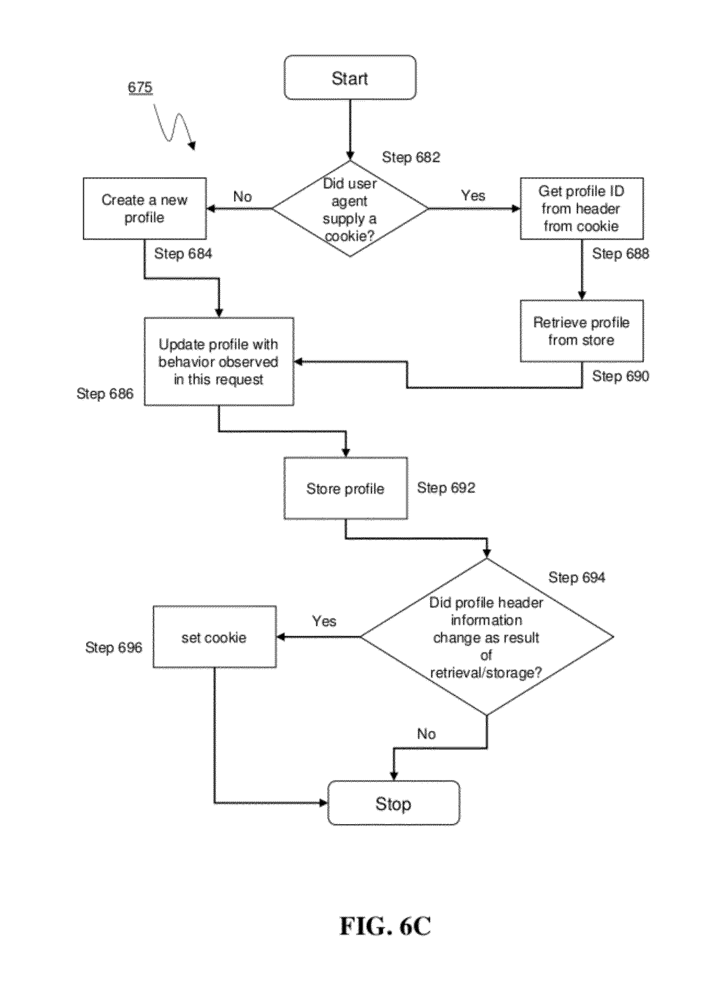

Referring now to FIG. 6A, a block diagram of an embodiment of a system for using the behavioral history of a user to provide content to the user is depicted. In brief overview, the system includes a client agent 520 executing within a webpage 517 loaded by a web browser 515 executing on a client 130. The client agent 520 communicates over a network 140 with the content providers' servers 120. The client agent 520, also communicates with an augmentation server 110 over a network 140. The augmentation server 110 may include a profiler 610 and a campaign selection manager 506. The augmentation server 110 may also include a user profile storage 620, campaigns 526, and ranked key words 528. The client agent 520 communicates the page content 519 over the network 140 to the augmentation server 110. The augmentation server processes the page content 519 in view of or based on the user profile and communicates keywords and campaigns 530 over the network 140 back to the client agent 520.

The user profile may comprise any type of data or information regarding a user, including but not limited to, the identify of a user, history of the user's behavior, or interactions of the user with an identified web page. In some embodiments, each user tracked by the behavioral engine (which also may also be referred to as a profiler, a profile engine, a profiling engine or similar term) has data stored in a user profile. In other embodiments, more than one user may be tracked by a user profile. Each user may be associated with a unique identifier. A user profile may comprise a unique identifier. The unique identifier or unique ID may be generated by any means, such as a randomizer. The identifier may comprise letters, number, symbols, or any combination thereof. The identifier may be generated using specific information about the user, such as an IP address or login information. In some embodiments, a unique ID is assigned to each user. In other embodiments, a unique ID is assigned to an IP address. In other embodiments, the unique ID is created based upon unique identifying information. In some embodiments, the unique ID may be generated from global cookies.

The user profile may be stored in any storage form, structured or unstructured, including but not limited to a text file, database, table, hash table, linked list, data structure, or other type of storage. The user profile may comprise a log of all the activities of the user when interacting with an identified webpage. In some embodiments, the activities may include clicking on links, conducting searches on the website, or any other type of activity a user may perform in conjunction with a website. The user profile may contain secondary information about a user's activities, such as calculating or maintaining statistics related to the number of mouse clicks a user may generate while on a webpage or categorizing keywords into broad categories and calculating or maintaining statistics related to the broad categories. User profiles may be imported from another location or created responsive to received user profile information. User profile information may be received from a client agent executing on a client, a remote server, content providers' server, or imported from another server. User profiles may be stored in a database. In some embodiments, the user profile is stored in a database within the profiler. In other embodiments, the user profiles may be stored in a remote database. In still other embodiments, the user profiles may be stored in a replicated database.

User profiles may comprise or identify a working set. In some embodiments, a working set may comprise a collation of terms that appear together repeatedly on websites visited by a user. In other embodiments, a working set may comprise terms generated by the behavioral engine responsive to terms that repeatedly appear on websites visited by a user. In still other embodiments, a working set may comprise a collection of words stored in the system which may be related to identified terms from websites visited by a user. A user profile may comprise working set metrics. In some embodiments, the working set metric is a collection of metrics or statistics. In some embodiments, each metric may comprise an identifier for an identified term and associated statistical data regarding the term. Some examples of associated statistical data regarding the term may include the number of times the term appears on a web page, the number of times a user clicks on the identified term, the number of related terms, or the number of appearances of the term within a pre-determined or specified time range. These metrics may include counts of activities, terms, searches, etc. These metrics may include an temporal information of activities, terms, searches, etc.

The profiler may comprise any type of hardware or software executing on hardware that creates, modifies, tracks, or otherwise processes a user profile and any data or information stored therein. The profiler, which may also be called a user profile engine, user profile generator, profile generator, or similar, may comprise any type and form of executable instructions executable on a device. The profiler may comprise any logic, function or operation to create, maintain, modify, or process a user profile. In some embodiments, the profiler may receive any type of user profile information from any source, such as a client agent executing on a client, a content provider's server, or a third party server. The profiler may query the user profile storage to determine whether a user profile exists for an identified user. A user may be identified by using a unique identifier or other identifying information, such as an IP address. The profiler may be in consistent or constant communication with a client agent to capture a user's behavior. The profiler may receive keystrokes, mouse movements, searches, and other behavior captured by a client agent. The profiler may receive user profile information at the end of a session. In other embodiments, the profiler may receive user profile information at pre-determined time intervals. In other embodiments, the profiler may receive user profile information as triggered by specified events by the user.

The profiler may receive user profile information from any source and may use the user profile information to create, edit, or modify a user profile. User profile information may be received by the profiler from a plurality of sources. In some embodiments, user profile information may be received from agents executing on a client. In other embodiments, user profile information may be received from web beacons embedded on a particular web page. In still other embodiments, user profile information may be received through API calls. In still other embodiments, user profile information may be received from servers.

The profiler may communicate with the campaign selection manager to process data related to a user. The profiler may receive user profile information from another device. The profile may update, modify, or otherwise process a user profile with the received user profile information. In some embodiments, the profiler identifies a user profile and communicates the entire profile to the campaign selection manager. In other embodiments, the profiler extracts key words and campaigns previously identified and stored in the user profile and communicates the information to the campaign selection manager. In other embodiments, the profiler updates, modifies, or processes the user profile using the received user profile information and communicates to the campaign manager the entire history of a user. In other embodiments, the profiler communicates to the campaign selection manager the newly received user history from the user profile information with only a predetermined portion of the user history stored in the user profile. The profiler may communicate to the campaign selection manager using any type of messaging. In some embodiments, the profiler maintains an open communication channel with the campaign selection manager and continuously sends information to the campaign selection manager.

Referring now to FIG. 6B, a flow diagram depicting an embodiment of steps of a method for using the behavioral history of a user to provide personalized, customized or targeted content to the user is depicted. In brief overview, at step 652, a client agent track a user's interaction with keywords on web pages. At step 654, a profiler receives the user's interactions from the client agent. At step 656, the profiler stores the received user's interactions. At step 658, the server receive from the client agent content of a webpage being loaded on the client for the user. At step 660, the server determines keywords from the content of the web page that match a predetermined set of keywords of campaigns for the web page. At step 662, the server identifies the matching keywords stored in the user profile. At step 664, the server changes a ranking of the matching keywords based on the user profile. At step 668, the server transmits to the client agent a set of matching keywords and their corresponding campaigns based on the changed ranking. Following any of the embodiments of step 594 and 596 referred to in FIG. 5K, the agent hooks the keywords, detects mouse over of keyword an displayed augmented content targeted, personalized or customized for the user based on the user's profile

Further referring to FIG. 6B, and in more detail, the client tracks a user's interaction with keywords on web pages (Step 652). Any embodiment of the client agent may perform the tracking of the user's interaction with the web page. The client agent may track the user's interactions responsive to or triggered by an attribute or setting in a cookie. The client agent may track the user's interactions responsive to or triggered by the server. The client agent may track the user's interactions upon loading the page. The client agent may track the user's interactions upon the user's first interaction with the page. The client agent may track the user's interactions upon a predetermined event on the page. The client agent may track the user's interactions upon a predetermined activity or interaction of the user.

The client agent may track any click of any input device, such as any mouse click. The client agent may track any user's scrolling behavior. The client agent may track location of any user's input device, such as location of mouse over. The client agent may track any user's highlighting, selection or clicking of any term, keyword, image, hyperlink or element of a web page. The client agent may track any of the URLs in the web page. The client agent may track any requested URLs. The client agent may track any IP addresses or domain names of visited pages or requested content. The client agent may track the user's interactions related to keywords and any metrics thereof. The client agent may track any temporal or historical information regarding user activity, including date and time of interaction, length of interaction, stop and start times of interactions, etc. The client agent may track content user interacted with by any type of categorization or scheme.

In some embodiments, the client agent determines whether a user profile exists for the user. The client agent may determine the existence of a user profile by using the unique identifier embedded in a cookie. If a user profile does not exist, the client agent may request a new user profile. If a user profile does exist, the client agent may retrieve or obtain the user profile from storage. The user profile may contain a working set or a set of key terms. If the profile does not contain any terms, terms may be generated based upon the terms listed on the webpage. In some embodiments, a working set may be generated once the user clicks on a keyword on the webpage. In other embodiments, a working set may comprise only of keywords selected by the user. In some embodiments, the interactions of the user are stored in a local log file by the client agent. User interactions with the web page may include clicking on keywords, hovering over keywords, and searching for terms.

The client agent may store the tracking of user interactions in any form, including memory or storage. In some embodiments, the client agent stores user interactions in a file, which may be referred to as a log file. In some embodiments, the client agent makes API calls to store the user interactions in a database, such as on a server.

At step 654, a profiler receives the user's interactions from the client agent. In some embodiments, a log file created by the client agent may be transmitted to the profiler. This log file may be referred to as a keyfile and may identify keywords or terms on pages visited by the user or interface with by the user. In some embodiments, the log file is transmitted to the profiler after the user's interactions with the web page are complete. In other embodiments, the log file may be transmitted in it entirety on a periodic basis. The periodic basis may be pre-determined or user-specified. In other embodiments, the log file may be transmitted in portions on a periodic basis. For instance, data may be transferred when a threshold is triggered, such as a predetermined number of keywords or a predetermined period of time. In other embodiments, the log file may be transmitted from the client agent to the profiler on a continuous basis, as the interactions are recorded in the local log file. In other embodiments, the log file may be transmitted from the client agent on demand, such as by request of a server, the profiler or a user.

In some embodiments, the user's interactions are transmitted as soon as they occur. In some embodiments, the user's interactions may be buffered for a predetermined amount of time or a predetermined amount of data prior to sending the information to the profiler. In some embodiments, the user's interactions are streamed to the profiler in real-time. In other embodiments, the user's interactions are transmitted to the profiler upon certain triggering events, such as navigating away from a certain page or conducting a search or clicking a specified number of keywords.

At step 656, the profiler stores the received information regarding the user profile, such as the user's interactions tracked by the client agent. In some embodiments, the profiler transmits the received user's interactions to the database for storage. In some embodiments, the profiler processes the received user's interactions and generates various metrics for the user's interactions. Such metrics may include the number of keywords clicked, the time lapsed between clicks, and the keywords or terms categorized into pre-determined categories. Metrics may also comprise statistics related to the keywords, including the number of times the keyword appears on a page and number of related words. In some embodiments, the profiler may transmit the user's interactions and the generated metrics to a database for storage.

At step 658, the server receives from the client agent content of a webpage, such as the web page currently being loaded on the client for the user. As described in connection with 5K and in view of any embodiments of step 580, the client agent sends and the server receives page data.

At step 660, the server determines keywords from the content of the web page that match a predetermined set of keywords of campaigns for the web page. As described in connection with 5K and in view of any embodiments of steps 582 through 590, the server may analyze page data, match campaigns to content filter, rank keywords based on criteria, match keywords to campaign keywords and select top matching keywords with their campaigns.

At step 662, the server identifies the matching keywords stored in the user profile. The server may identify or obtain metrics of the matching keywords stored in the user profile, In some embodiments, the server identifies or obtains all the keywords and/or their metrics stored in the user profile. In some embodiments, the server identifies or obtains a portion of the keywords and/or their metrics stored in the user profile. The server may query one or more keywords and/or their metrics from the user profile. The server may query one or more keywords and/or their metrics from the user profile using any query parameters, such as time, subject matter, category, web page, content provider, URLs, content, etc. In some embodiments, the server identifies the one or more keywords based on any metric, such as top interacted keywords, top viewed keyword, etc.

During any portion of any embodiments of FIG. 5K, the server may identify any keywords matching keywords stored in the user profile. In some embodiments, the server may use the keywords stored in or identified via the user profile for ranking keywords at any embodiments of step 586. In some embodiments, the server may use the keywords stored in or identified via the user profile for matching ranked keywords to keywords of campaigns in any embodiments of step 588. In some embodiments, the server may use the keywords stored in or identified via the user profile to select top matching keywords with their campaigns.

At step 664, the server may change a ranking of the matching keywords based on the user profile, such as based on any metrics of keywords, including working sets or otherwise. In some embodiments, the server does not change the ranking based on the user profile. In some embodiments, the server only changes a portion of the ranking based on the user profile. In some embodiments, the server changes the entire ranking based on the user profile. The server may change any of the matching keywords from any of steps 584 through 590 based on the one or more keywords identified via the user profile.

The server may upweight a metric of a keyword in the ranking based on metrics of the keyword from the user profile. The server may downweight a metric of a keyword in the ranking based on metrics of the keyword from the user profile. The server may combine, mathematically or otherwise, a metric of a keyword in the ranking with a metric of the keyword from the user profile. The server may generate an updated metric of the keyword for the ranking based on or using the metric of the keyword from the user profile. The server may generate a new metric for the keyword for the ranking based on or using the metric of the keyword from the user profile. The server may update the ranking of keywords based on the changes to the metrics.

At step 668, the server transmits to the client agent a set of matching keywords and their corresponding campaigns based on the changed ranking. The server may set matching keywords influenced by the user profile to have keywords and corresponding campaigns personalized or targeted to the user or the user's behavior. Step 668 may include any embodiments of step 592 in connection with FIG. 5K. The server sends to the agent the selected keywords and their campaigns and may provide the agent tooltips and/or augmented content. The client agent may perform any of the embodiments of step 594 and/or 596: the agent hooks the keywords and/or detects user interaction such as mouse over or click of keywords and displays augmented content, such as a tooltip.

Referring now to FIG. 6C, a flow diagram depicting an embodiment of steps of a method 675 for using cookies with user profiles is depicted. In brief overview, at step 682, it is determined whether the user agent supplied a cookie. If no, then at step 684 a new user profile is created and at step 686 the profile is updated with behavior observed in the request. If, at step 682, the user agent supplied a cookie, then at step 688 a profile ID is retrieved from the header of the cookie and is used at step 690 to retrieve the user's profile from storage. At step 686 the retrieved profile is updated with behavior observed with the request. At step 692 the updated profile is stored. At step 694, the system determines whether the profile header information changed as a result of the retrieval or storage of the user profile. If yes, the cookie is set at step 696. If no, then the method terminates.

Further referring to FIG. 6C, and in more detail, in one embodiment, the method determines whether the user agent 520 supplied a cookie (Step 682). In some embodiments, the cookie comprises a unique user ID, header information used by the profiler 610 used to locate the profile for the user in the user profile storage 620, and cookie creation and expiration dates. In some embodiments, the cookie is sent by the client agent 520 at the beginning of a session. In other embodiments, the cookie is sent by the client agent 520 only when requested by the profiler 610. In some embodiments, the cookie is sent with each request to the augmentation server 110. In other embodiments, the cookie is sent via HTTP. In some embodiments, the cookie content is encoded and cannot be read directly from the user's cookie store. In some embodiments, the header information of the cookie is encoded. In some embodiments, the cookie contains human-readable information.

If the client agent 520 did not send a cookie, at step 684, the profiler 610 creates a user profile. The profiler 610 communicates with the user profile storage to create a unique identifier for the user profile. In some embodiments, the unique identifier is randomly generated by the profiler 610 and checked against existing unique identifiers. In some embodiments, the unique identifiers may be stored in a table, database, hash table, or other similar data structure, which the profiler 610 queries or checks prior to assigning a new identifier to the newly created user profile.

In some embodiments, the profiler 610 populates the user profile with keywords pre-determined for the page the user requested. In other embodiments, the profiler 610 creates a new user profile but does not add any keywords until user interactions are received from the client agent 520. In some embodiments, user profiles may be grouped by the profiler 610 responsive to a characteristic of the group, such as geographic location, type of computer, or other types of information. The profiler 610 may populate the newly created user profile responsive to the group type or common feature of the group members.

If the client agent 520 did supply a cookie, then at step 688, the profiler 610 retrieves the header from the cookie. In some embodiments, the header may be encoded. If the header is encoded, the profiler may decode the header in order to retrieve the content of the cookie. In other embodiments, the profiler may communicate with another application or function executing on the augmentation server 110 to decode the encoded portion of the cookie. In some embodiments, the profiler transmits the entire cookie to the application or function to decode the encoded content. In other embodiments, the profiler transmits only the encoded portion to the application or function to decode the encoded content.

After the content has been retrieved from the header, at step 690, the profiler 610 uses the information received through the cookie to identify the existing user profile. In some embodiments, the profiler retrieves the identified user content from the user profile storage 620. In other embodiments, the profiler 610 references a table or data structure to determine the location of the profile and retrieves the profile from the appropriate location.

After a new user profile is created or an existing profile is retrieved, at step 686, the profiler 610 updates the profiler with the user interactions received from the client agent 520. In some embodiments, the user interactions contain only key words from the web page. In other embodiments, the user interactions may include keywords as well as information reflecting the actions of the user while interacting with the webpage. User interactions may include the number of clicks on a keyword or related keywords, how long the user remained on a web page, and the searches the user conducted while on the webpage.

After the profiler 610 updates the profile with the received user interactions from the client agent 520, at step 692, the profiler stores the modified user profile. In some embodiments, the profiler stores the user profile in the same location from where it retrieved the profile. If the user profile was newly created, the profiler may query the user profile storage 620 to determine a location for the profile. In some embodiments, the profiler 610 may determine where to store the profile based on its size. In other embodiments, the profiler 610 may determine the storage location based upon the updated content. In other embodiments, the profiler 610 may determine the storage location based upon the frequency of the retrieval of the profile. In other embodiments, the location of storage may be determined randomly.

At step 694, the profiler 610 determines whether the header information has changed as a result of the retrieval or storage of the cookie. If the profile header information has changed, then at step 696, the profiler sets the cookie prior to transmitting the cookie back to the client agent 520. In some embodiments, the profiler 610 encodes the changes of the cookie prior to sending it back to the client agent. In other embodiments, the profiler 610 modifies the header information without encoding the content and sends the cookie back to the client agent 520. After the profiler 610 sets the cookie and transmits the cookie back to the client agent 520, then method terminates.

If the profiler 610 determines that no profile header information changed as a result of the retrieval or storage of the profile, then the method may terminate.

In view of the systems and methods described herein, an exemplary embodiments is now described. Embodiments of the systems for user profiling may be referred to as behavioral targeting system or a behavioral system. The behavioral targeting system may provide a way of tracking a user across various partner sites. The data tracked may include terms which exist in the keyfiles on each page the user visits. The terms which repeatedly appear on pages which users view are determined to be indicators for topics that interest the user. In some embodiments, the system may weight the identified terms. For example, if a user reads multiple articles about SUV on websites, then the terms that exist in the keyfiles of the car websites will be weighted higher in the behavioral targeting system so that the relevancy values for SUV-related keywords are increased for that user.

In some embodiments, there may be several parameters that govern the behavior of the behavioral engine. For example, these switches can be channel-level script parameters, as listed below:

behavioral=1

behavioral db=1

ubehavioral=3.0

In the example, the first switch (behavioral=1) enables the tracking of behavioral data. In this example, the engine, such as the profiler, begins tracking terms presented to the user and builds keyword or working sets. In some embodiments, the default of the system is to have this feature disabled.

The second switch (behavioral db=1) may enable debugging information of behavioral data. In some embodiments, this setting is not displayed by default. In the case the switch is enabled, in-depth behavioral data will be displayed.

The third switch (ubehavioral=3.0) enables ranking or rating keywords which are detected in a user's profile and specifies the variable by which the term should be modified. In some embodiments, the default of the third switch is set to 0.0. In other words, the default is to have this feature disabled.

For example, given the web site:

http://www.anandtech.com/mb/showdoc.aspx?i=3229

The system may produce the following output:

door.jsp

Build: DEVELOPMENT

Your IP: 127.0.0.1

Your user cookie: G/Zt5wSbwRFKHOD7dj1NVbwAANn4AADa6AQoJBhU-

Decoded user cookie:

com.vibrantmedia.intellitxt.support.UserID[uuid=FD9B79C126F0445287383EDD8E535 56F,header=[/10.9.6.21],createDate=Wed Mar 12 01:00:00 GMT 2008,i Sun May 11 01:00:00 BST 2008]

Cookies Enabled: true

The information in the cookie has been expanded to cater for behavioral.

Upweighting keywords in title by 2.0

UPWEIGHTED: asus by 2.0 to 53.571426

Not upweighting keywords in google search terms

Not using behavioral engine

The above snippet indicates that the behavioral engine has not been enabled. In order to enable the behavioral engine, the following de-bug switch may be added:

itxtparm-behavioral=1

Once the page has been refreshed, a new debug trace may be generated, which may indicate the behavioral engine has been enabled:

Upweighting keywords in title by 2.0

UPWEIGHTED: asus by 2.0 to 53.571426

Not upweighting keywords in google search terms

Behavioral engine enabled

Not upweighting behavioral keywords

Last Modified=12 Mar. 2008 21:21:02

Hits=3

Working set size=128

As discussed above, if the upweighting factor is set to 0.0, then keywords may not be upweighted or otherwise modified. The behavioral engine may persist in information gathering mode.

The behavioral data, which may be stored in a working set, is persisted to the profile server. The above debug trace indicates that the user's profile has been used three times (3 hits) and currently holds 128 pieces of data (working set size=28).

### Behavioral Engine Enabled

### Not Upweighting Behavioral Keywords

### Normalised Keywords (64 in Weight Descending Order)

TABLE 1

| Keyword | Weight | NormalisedWeight |
|---|---|---|
| intel | 89.67857 | 0.06374148 |
| nvidia | 62.107143 | 0.044144336 |
| chipset | 61.750004 | 0.04389049 |
| asus | 53.571426 | 0.038077343 |
| graphics | 41.357143 | 0.029395713 |
| overclocking | 40.821426 | 0.029014936 |
| intel chipset | 36.3125 | 0.025810095 |

The behavioral engine has been enabled and the table displays a list of words passed to the behavioral engine from the keyfile with their weightings. These weightings are normalised. In some embodiments, the weightings are normalized by adding all the weights for those keywords and then dividing each keywords weight by the total. The total of the normalised weightings is 1.0.

Next, the following table is generated:

Start of merge table

TABLE 2

| keyword | hits | metric weight | keyword weight | new weight |
|---|---|---|---|---|
| amd | 3 | 0.013230889 | 0.019571755 | 0.015344511 |
| ati radeon | 3 | 0.011471919 | 0.016969804 | 0.0133045465 |
| asus | 5 | 0.014895206 | 0.038077343 | 0.019531634 |
| business | 3 | 0.0066240253 | 0.009798571 | 0.0076822066 |
| bios | 3 | 0.0063837757 | 0.009443182 | 0.007403577 |
| chipset | 5 | 0.019897144 | 0.04389049 | 0.024695814 |
| compatibility | 3 | 0.006658346 | 0.00984934 | 0.0077220104 |
| chipsets | 5 | 0.0069240676 | 0.014494776 | 0.008438209 |
| development | 3 | 0.0066240253 | 0.009798571 | 0.0076822066 |

In some embodiments, the keywords from Table 1 are merged with the keywords of the behavioral set displayed in Table 2. The example working set track the 1000 most important keywords for that user (those with the highest weights). The hits column is the number of times the keyword has appeared on a page (not necessarily hooked) since that keyword appeared in the working set. The weight is the current calculated weight.

The weight values are calculated from the base weight, seen in the keyfile with the various upweight multipliers assigned. For example, if the weight is designated x for that keyword, the current computed weight calculated by taking the base keyword weight (relevancy value from the keyfile) multiplied by the upweighting mechanisms that have been applied thus far (title keyword upweighting, google search term upweighting, behavioral upweighting etc).

If the number of metrics (keywords and related info) in the working set exceeds a predetermined threshold such as 1000 then having done the normal behavioral processing for the page, the metrics may be ordered by weight descending, pick the top 1000 and bin the rest.

In one example, a webpage displaying motherboards, may generate the following start of merge table:

TABLE 3

| keyword | hits | metric weight | keyword weight | new weight |
|---|---|---|---|---|
| abit | 2 | 0.007992663 | 0.013460363 | 0.010726513 |
| access | 2 | 0.007888863 | 0.013285554 | 0.010587208 |
| asus | 7 | 0.010062336 | 0.013460363 | 0.010547767 |
| beta | 2 | 0.007888863 | 0.013285554 | 0.010587208 |
| business | 5 | 0.0051404713 | 0.013809984 | 0.0068743736 |
| bios | 5 | 0.004950533 | 0.013285554 | 0.0066175372 |
| chipset | 7 | 0.012405215 | 0.013809984 | 0.012605896 |
| company | 4 | 0.0040898826 | 0.013285554 | 0.0063888 |
| computer | 2 | 0.007888863 | 0.013285554 | 0.010587208 |
| downloads | 2 | 0.007888863 | 0.013285554 | 0.010587208 |
| gigabyte | 5 | 0.004992496 | 0.013460363 | 0.00668607 |

Table 3 demonstrates an embodiment of the merging data from the existing working set with the keywords found on the page. If a word appears on the page and didn't exist in the working set then the hits and metric weight columns will be blank because there is no previous data. The keyword weight column indicates that the normalized keyword of the keyword and the new weight column indicates the merged weight. For a new keyword, the keyword weight is listed but for existing keywords the rolling average of the keyword may be used.

In some embodiments, the rolling average for a keyword is the metric weight value multiplied by the number of hits. This value may be added to the keyword weight and divided by hits+1. In some embodiments, this generates the average weight of that keyword over that many pages.

The merged result of the page may generate the following table of merged normalized keywords (e.g., 155 in weight descending order)

TABLE 4.1

| Keyword | Hits | Weight |
|---|---|---|
| foxconn | 2 | 0.09129075 |
| god of war | 2 | 0.08885394 |
| product | 5 | 0.019562762 |
| the world | 2 | 0.016641544 |
| nvidia nforce | 2 | 0.016433522 |
| latest technology | 2 | 0.016017484 |
| performance | 7 | 0.015110723 |
| quantum | 2 | 0.0134915365 |
| intel | 7 | 0.0134266205 |
| motherboards | 5 | 0.011538727 |
| chipset | 7 | 0.01075651 |
| products | 5 | 0.01046648 |
| overclocking | 3 | 0.010411438 |

TABLE 4.2

| | | |
|---|---|---|
| speakers | 2 | 0.0017748069 |
| games | 2 | 0.0017591008 |
| processor | 2 | 0.0017591008 |
| video | 2 | 0.0017591008 |

Last Modified=12 Mar. 2008 21:57:41

Hits=7

Working set size=155

Table 4.1 indicates an embodiments in which the most relevant keyword in the working set for the user is “foxconn.”

In this example, the third switch is set to a value of 8.0 (ubehavioral=8.0). By setting the third switch, keywords found on the page which also appear in a user's profile will be upweighted by a factor of 8.0.

This will cause keywords found on the page which also appear in the behavioral profile to be upweighted by a factor of 8.0. Then any upweighted keywords will be noted in the “ur” and “uf” parameters in both urls (for hooks, adviews and clicks) and in the loggingstorage stats file.

To further our example:

Behavioral engine enabled

Upweighting behavioral keywords by 8.0

CANCELLING UPWEIGHTING: Profile has had 9 hits but needs at least 50

If a behavioral profile has not been exposed to at least 50 page views then it is indicative that there is not enough data to start upweighting keywords. In such cases, the engine should remain in data-gathering mode.

In other embodiments, each time a user views a page the system writes the user's unique id and the list of keywords and weights of the sold terms on that page to a new logfile (referred to in some embodiments as a keyfile). This logfile is periodically sent back to a server, such as a central database for processing and provides the data from which “contextual history avails” are generated. These contextual history avails may indicate which keywords were available from a behavioral perspective.

The server or central databases may import these logfiles to generate the “avails” data. The databases may also keep track of all the keywords that appeared on pages that each user visited. For example, if for the last 24 hours, for each user the complete set of keywords that existed on pages that the user visited is found. If the user is an existing or previously identified user, then the system may merge the last 24 hours worth of keywords with any keyword data previously processed for this user. This generates a running overview of what keywords were most relevant on pages which the user has visited over the lifetime of their profile. This list of keywords is what forms their profile.

The central database may directly or via the regional servers make available a snapshot of the most active user profiles. The web servers may import this data and use such data for the next 24 hours. This means the profile data the web servers use over a 24 hour period is directly available to them, but may become progressively more stale. There may be a maximum number of keywords that are allowed to exist in the user's profile and each keyword has an associated weight. The weight may indicate how important/relevant this keyword is to that user. In some embodiments, the maximum number of keywords in a profile may not exceed 1000, although any maximum threshold may be used.

When processing a user's profile, the set of keyword data generated within the last 24 hours may be used. These are the keywords that appeared on pages the user's recently viewed. This set of keywords is known as K. Each of these keywords has the following properties:
K=set of keywords
K.length=number of keywords in set
K.keyword=for any item in set K this is the keyword
K.weight=the sum of the weights for K.keyword

K.hits=the number of times K.keyword appeared on pages

The previous contents of the user's profile may also be available, and is known as P and each keyword within P has similar properties to K above. The data (K) for a user who has no previous profile (P) then has P.length of 0.

To calculate the new state of a user's profile there are two example embodiments of code. The first indicates that if no previous profile existed then the profile may become the set of keywords passed in. If a profile does exist then the profile “merge” is applied to the new keywords into the existing profile. Note that the merge process may be effectively calculating a weighted average rather than a simple sum. The following is an en embodiment of pseudo code for this process:

if P.length < 1

P.add(K)

else

for each k in K

if P.contains(k.keyword)

m = P(k)
float weight = m.weight;
weight *= m.hits;
weight += k.weight;
m.hits++;
weight /= m.hits;
m.weight = weight

else

P.add(k)

if p.length > 1000

sortByWeightDescending(P)
P = P.sublist(0, 1000)

If there are more than 1000 (e.g., example maximum threshold) entries in the profile then the function sortByWeightDescending( ) is called, which sorts the keywords in set P by the weights descending (highest first). This is followed by P.sublist(0, 1000) which sets P to be the first 1000 (and therefore highest weighted) keywords in P.

The approach is that keywords which have a high (relevancy) weighting that repeatedly appear on pages the user visits will naturally move towards the top of the user's profile, and keywords which are less relevant and/or don't appear often (or even disappear) will move to the end of the profile and drop off.

Although embodiments are generally discussed as making data available for user profiles on a 24 hour basis, any temporal basis may be used, including longer or shorter basis or on a real-time or near real time basis.

In some embodiments, the output data sent to the web servers with the most active users' profiles may be a table comprising the following data:

TABLE 5

| Field Name | Data Type | Description |
|---|---|---|
| UserID | Varbinary(16) | User id as a UUID/GUID |
| KeywordID | Int | ID of keyword in profile |
| Weight | Float | Weight of keyword in profile |

In some embodiments, there is a primary key on UserID.

In some embodiments, better performance may be effectuated by having a users table which maps a UserID value to an int-based key, and then have a secondary table which has an int-based user id rather than a uuid-based key. When retrieving the data on the web nodes a join may be performed.

What is claimed is:

1. A method for selecting keywords to augment on a web page based on a behavior history of a user, the method comprising:
(a) storing, by a profiler to a user profile, interactions of a user, received from an agent of a client, with one or more keywords on one or more web pages visited by the user, the one or more keywords augmented with content from the server;
(b) receiving, by the server from the agent of the client, content of a web page being loaded on the client for the user;
(c) determining, by the server, keywords from the content of the web page that match a predetermined set of keywords of one or more campaigns for the web page;
(d) identifying, by the server, one or more of the matching keywords are stored in the user profile;
(e) changing, by the server responsive to the identification, a ranking of the matching keywords based on the user profile; and
(f) transmitting, by the server to the agent, a set of matching keywords and their corresponding campaigns based on the changed ranking.

2. The method of claim 1, wherein step (a) further comprises assigning, by the profiler, a unique identifier to the user.

3. The method of claim 2, wherein step (a) further comprises transmitting, by the server to the client of the user, a cookie comprising the unique identifier of the user.

4. The method of claim 1, wherein step (a) further comprises determining, by the server, one or more metrics for the one or more keywords and storing the one or more metrics to the user's profile.

5. The method of claim 4, further comprising merging, by the profiler, the one or more metrics with keyword metrics stored in the user profile and storing the merged keyword metrics to the user profile.

6. The method of claim 4, further comprising calculating, by the profiler, a weighted average of the one or more keyword metrics and keyword metrics stored in the user profile and storing the weighted average keyword metrics to the user profile.

7. The method of claim 1, wherein step (b) further comprises identifying, by the agent, a mouse over of one or more keywords on each web page the user visits, and transmitting the identified one or more keywords to the profiler to store to the user profile.

8. The method of claim 1, wherein step (b) further comprises identifying, by the agent, a click of one or more keywords on each web page the user visits, and transmitting the identified one or more keywords to the profiler to store to the user profile.

9. The method of claim 1, wherein step (c) further comprises ranking, by the server, the matching keywords.

10. The method of claim 1, wherein step (d) further comprises assigning, by the server, a weighted score to each of the one or more matching keywords.

11. The method of claim 1, wherein step (e) further comprises upweighting, by the server, a metric for a keyword previously stored in the user profile and received by the server for the web page.

12. The method of claim 1, wherein step (f) further comprises determining, by the server, one or more keywords to augment on a second web page based on a first set of keyword metrics stored in the user profile and a second set of keyword metrics identified for the currently displayed second web page.

13. A system for selecting keywords to augment on a web page based on a behavior history of a user, the system comprising:
a profiler storing to a user profile identified by a unique identifier interactions of a user, received from an agent of a client, with one or more keywords on one or more web pages visited by the user, the one or more keywords augmented with content from the server;
a server receiving from the agent content of a web page being loaded on the client for the user and determining keywords from the content of the web page that match a predetermined set of keywords of one or more campaigns for the web page; and
wherein the server identifies that one or more of the matching keywords are stored in the user profile and changes, responsive to the identification, a ranking of the matching keywords based on the user profile, and
wherein the server transmits to the agent a set of matching keywords and their corresponding campaigns based on the changed ranking.

14. The system of claim 13, wherein the by the profiler assigns a unique identifier to the user.

15. The system of claim 14, wherein the server transmits to the client of the user, a cookie comprising the unique identifier of the user.

16. The system of claim 13, wherein the server determines one or more metrics for the one or more keywords and stores the one or more metrics to the user profile.

17. The system of claim 16, wherein the profiler merges the one or more metrics with keyword metrics stored in the user profile and stores the merged keyword metrics to the user profile.

18. The system of claim 16, wherein the profiler calculates a weighted average of the one or more keyword metrics and keyword metrics stored in the user profile and stores the weighted average keyword metrics to the user profile.

19. The system of claim 13, wherein the agent identifies a mouse over of one or more keywords on each web page the user visits, and transmits the identified one or more keywords to the profiler to store to the user profile.

20. The system of claim 13, wherein the agent identifies a click of one or more keywords on each web page the user visits, and transmits the identified one or more keywords to the profiler to store to the user profile.

21. The system of claim 13, wherein the server ranks the matching keywords.

22. The system of claim 13, wherein the server assigns a weighted score to each of the one or more matching keywords.

23. The system of claim 13, wherein the server upweights a metric for a keyword previously stored in the user profile and received by the server for the web page.

24. The system of claim 13, wherein the server determines one or more keywords to augment on a second web page based on a first set of keyword metrics stored in the user profile and a second set of keyword metrics identified for the currently displayed second web page.
